(19) United States
(12) Patent Application Publication
(10) Pub. No.: US 2003/0217111 A1
(43) Pub. Date: Nov. 20, 2003

(54) Method and system for implementing an information portal for viewing information from disparate system's databases

(76) Inventor: John T. McKay, Corunna, MI (US)

Correspondence Address: JONES DAY, P.O. BOX 660623, DALLAS, TX, 75266-0623, US

(21) Appl. No.: 10/146,852

(22) Filed: May 15, 2002

(51) Int. Cl. G06F 15/16

(52) U.S. Cl. 709/207

(57) ABSTRACT

The present invention provides a means for an enterprise, such as a health care facility, to view information as it resides in the individual disparate system's databases. As information portal is created into all of these systems by connecting one server to all of these data sources and push data to the user via a web browser based on a set of business rules. Dynamically deciding what to display for the user and what not to display would reduce the “time to market” for the data to the user and allow the user to make more intelligent, more accurate conclusions in his/her job. By leaving the data intact and in-place, the cost associated with such an enterprise project is eliminated and its accuracy is guaranteed at the time the user requests the data. The information portal has a database to house profile information about the users; names, departments, phone numbers, pager numbers, etc., and then use this data to build an online “Corporate Directory” for employees to search.

### CROSS REFERENCES TO RELATED APPLICATIONS

The present application is referenced to and claims priority from provisional U.S. patent application Ser. No. 60/291,301 filed on May 15, 2001 titled “METHOD AND SYSTEM FOR IMPLEMENTING AN INFORMATION PORTAL FOR VIEWING INFORMATION FROM DISPARATE SYSTEM'S DATABASES” which is assigned to the assignee of the present invention.

### BACKGROUND OF THE INVENTION

1. Field of the Invention

The present invention relates generally to information services systems and more particularly to assimilating and accessing data stored in disparate, ancillary systems. Still more particularly, the recent invention relates to the distribution and administration of medical services by presenting and/or accessing information at an enterprise level, which has been entered and stored in an ancillary system level.

2. Description of Related Art

A commercial enterprise, or enterprise, may be defined as a unit of economic organization or activity, especially a business organization for undertaking a project, especially a difficult, complicated or risky project. An enterprise may evolve in response to a need, which has been unfulfilled. Thus, the underlying goal of any enterprise is to successfully complete a common project or task. However, many commercial enterprises are compilations of enterprise departments that evolve to fulfill sub-tasks of the enterprise's primary task. These enterprise departments may originate autonomously from the enterprise to provide a solution for a task or instead, a department may be created internally by the enterprise for more effectively focusing on a particular sub-task. Independent enterprise departments may be acquired by an enterprise to supplement the enterprise's innate capacity. When properly integrated, the roles of individual enterprise departments are largely unrelated and dissimilar to other enterprise departments. The individual enterprise departments are supported by functional disparate systems.

One of ordinary skill in the art will understand that each of these enterprise departments may evolve its own particular infrastructure and culture. Individual enterprise departments most probably establish their own Information Systems Service (ISS) infrastructures based solely on their own information processing needs and budget constraints and without regard to the ISS needs of other enterprise departments. A department institutes its own information priori and database schema that shape its information system requirements. Individual enterprise departments establish relationships with hardware and software vendors based on that priori and set IS personal standards based on the vendor's products. As the role of the department changes within the enterprises, the department's vendors adjust their products accordingly, thus allowing the department to maintain or increase its market share in comparison to similar, but competing enterprise departments. Over the course of time, a department's vendor supplied applications become unique from other enterprise department's vendor supplied applications as each application provides ancillary functionality to all other department applications within the enterprise. In practice, the disparate, ancillary character of enterprise department applications and database structures is often beneficial to the enterprise because each department's applications are allowed to focus on the department's information priori with minimal interference from the enterprise of other department's information priori.

On the other hand, however, the information product of one department might be needed by another department for that department to expedite its enterprise sub-tasks. Therefore, a department needing another department's information product must either train its IS personnel on that department's applications or rely on that department to respond on request for its information product. Since enterprise departments relied on diverse vendor applications predicated on dissimilar information priori, information structures laced the coherence necessary for straightforward data exchange.

Most of these legacy systems are “departmental” type systems that were born out of need for an individual department. They do not take into account the whole picture for the organization, but rather focus on the specific need of the department they serve. In order to use these systems in an “Enterprise” manner, healthcare institutions have had to develop complicated Interfacing schemas that move data from one system to many of the other systems in the organization.

Most legacy systems in Healthcare offer an interfacing capability by using an outbound or inbound (or both) interface transmitter that sends/receives HL7 (Healthcare Level 7) formatted messages. This works fine for keeping systems current with data that was generated by another system. However, this creates multiple copies of the data in the organization and creates unproductive traffic for data that may or may not ever need to be analyzed.

Prior art in this arena has produced products that will replicate the data from all of these several disparate systems to a huge “data warehouse” that acts as a repository of data. These solutions use an application called an “Interface Engine” to determine what data (from what systems) should go into the repository and where in the repository the data should be stored. Communication between ancillary systems may take a number of forms, but for the purpose herein, the communications process occurs as depicted in FIG. 1. FIG. 1 shows several disparate, ancillary systems depicted as Admissions, Discharge and Transfers (ADT) 102, Radiology 104, Medical records/transcriptions 106, Pharmacy 108 and Laboratory 110. The depicted systems are merely illustrative of the disparate, ancillary systems that may be present within a health care enterprise and one of ordinary skill in the art would readily realize that other systems may be present in combination or in place of the exemplary systems. Each of the respective disparate, ancillary systems utilize servers 102A, 104A, 106A, 108A and 110A for processing information to and from their respective terminals 102C, 104C, 106C, 108C and 110C and storage units 102B, 104B, 106B, 108B and 110B. It is expected that any one users 102D, 104D, 106D, 108D and 110D initiate a trigger event by communicating with their respective servers 102A, 104A, 106A, 108A and 110A via respective terminals 102C, 104C, 106C, 108C and 110C.

The occurrence of the real world event triggers a message, in this case a HL7 compliant message, being sent. Message transactions are represented by arrows to and from each of the disparate, ancillary systems 102, 104, 106, 108 and 110 which are functionally connected to one another over a network such as a Local Area Network (LAN) or possibly a Wide Area Network (WAN). As discussed above, a trigger event causes information associated with the event to be sent to one or more ancillary systems. Many types of HL7 messages are generated in response to a trigger event. As such, the transaction is termed an “unsolicited update”. Ancillary applications that need event information from a trigger event must listen for a message containing the unsolicited update information values.

Example: patient demographic data should be stored in a “demographics” table vs. laboratory data being stored in a “lab results” table, etc . . . . Typically, HL7 format is used to capture the data from the disparate system(s) and then a SQL (Structured Query Language) statement is generated by the Interface Engine and executed in the database. The SQL statement actually performs the insert into the appropriate table and would look something like this: “INSERT INTO tablename VALUES (data, data2, data3, etc . . . )”

With regard to HL7, it will be understood by artisans as the atomic unit of data transferred between disparate system applications. Every message is structured as a group of segments in a defined sequence. Most messages are triggered by real world events and every message type defines the purpose of the message. For example, a patient being admitted to a health care enterprise triggers an ADT Message type A01. Below, Table I is a nonexhaustive list containing exemplary HL7 message types and descriptions of the message.

TABLE I
(HL7 Message Types)

| Message | Description |
|---|---|
| ACK | General acknowledgment message |
| ADR | ADT response |
| ADT | ADT message |
| DOC | Document response |
| PIN | Patient insurance information |
| ROR | Pharmacy/treatment order response |
| RAR | Pharmacy/treatment administration information |
| RAS | Pharmacy/treatment administration message |
| RDO | Pharmacy/treatment order message |
| RDR | Pharmacy/treatment dispense information |
| RDS | Pharmacy/treatment dispense message |
| SQM | Schedule query message |
| SQR | Schedule query response |
| SRM | Schedule request message |
| SRR | Scheduled request response |
| SUR | Summary product experience report |
| TBR | Tabular data response |

The ADT type A01 message is from Patient Administration (ADT) triggered by an event (A01) concerning a patient being admitted. The patient admission trigger event causes the ADT application to broadcast the ADT type A01 message to a predefined set of application socket addresses. The message body contains pertinent data describing the event. For the purposes of the description of the present invention, the exemplary discussions will refer to the HL7 messaging protocol adopted by the healthcare industry. The use of the HL7 standard is not meant to limit the scope or use of the present invention and, as ordinary artisans will readily realize, the present invention may be implemented in a variety of protocols adopted by various business enterprises without departing from the scope or intent of the present invention.

HL7 messages are composed of uniquely identified segments and each uniquely identified message segment is a logical grouping of segment fields. Below, Table 11 is a nonexhaustive list containing exemplary HL7 segment types and corresponding segment descriptions.

TABLE II
(HL7 Segment Types)

| Segment | Description |
|---|---|
| ACC | Accident segment |
| ADD | Addendum segment |
| AIG | Appointment information - general resource segment |
| AIL | Appointment information - location resource segment |
| AIP | Appointment information - personnel resource segment |
| AIS | Appointment information - service segment |
| AL1 | Patient allergy information segment |
| APR | Appointment preferences segment |
| ARQ | Appointment request segment |
| AUT | Authorization information segment |
| BLG | Billing segment |
| ERR | Error segment |
| EVN | Event type segment |
| FAC | Facility segment |
| FHS | File header segment |
| FT1 | Financial transaction segment |
| LCC | Location charge code segment |
| LCH | Location characteristic segment |
| LDP | Location department segment |
| LOC | Location identification segment |
| LRL | Location relationship segment |
| MFI | Master file identification segment |
| MSA | Message acknowledgment segment |
| MSH | Message header segment |
| PID | Patient identification segment |
| RXA | Pharmacy/treatment administration segment |
| RXC | Pharmacy/treatment component order segment |
| RXD | Pharmacy/treatment dispense segment |
| RXE | Pharmacy/treatment encoded order segment |
| RXG | Pharmacy/treatment give segment |
| RXO | Pharmacy/treatment order segment |
| RXR | Pharmacy/treatment route segment |

Every segment field is associated with a particular data element type and that association depends on the type of unique segment containing the segment field. Below, Table III is a nonexhaustive list containing exemplary HL7 data element types and corresponding specification for the data elements.

TABLE III
(HL7 Data Element Types)

| Element Type/Description | Item# | Seg | Seq# | Len | DT | Rep | Table |
|---|---|---|---|---|---|---|---|
| Accident Code | 00528 | ACC | 2 | 60 | CE | | 0050 |
| Accident Date/Time | 00527 | ACC | 1 | 26 | TS | | |
| Accident Death Indicator | 00814 | ACC | 6 | 12 | ID | | 0136 |
| Accident Job Related Indicator | 00813 | ACC | 5 | 1 | ID | | 0136 |
| Accident Location | 00529 | ACC | 3 | 25 | ST | | |
| Account ID | 00236 | BLG | 3 | 100 | CX | | |
| Account Status | 00171 | PV1 | 41 | 2 | IS | | 0117 |
| Acknowledgment Code | 00018 | MSA | 1 | 2 | ID | | 0008 |
| Admission Type | 00134 | PV1 | 4 | 2 | IS | | 0007 |
| Admit Date/Time | 00174 | PV1 | 44 | 26 | TS | | |
| Admit Reason | 00183 | PV2 | 3 | 60 | CE | | |
| Admit Source | 00144 | PV1 | 14 | 3 | IS | | 0023 |
| Admitting Doctor | 00147 | PV1 | 17 | 60 | XCN | Y | 0010 |
| Assigned Patient Location | 00133 | PV1 | 3 | 80 | PL | | |
| Assigned Patient Location | 00133 | FT1 | 16 | 80 | PL | | |
| Attending Doctor | 00137 | PV1 | 7 | 60 | XCN | Y | 0010 |
| Billing Category | 01007 | PRC | 14 | 60 | CE | Y | 0293 |
| Birth Order | 00128 | PID | 25 | 2 | NM | | |
| Birth Place | 00126 | PID | 23 | 60 | ST | | |
| Business Phone Number | 00195 | NK1 | 6 | 40 | XTN | Y | |
| Consulting Doctor | 00139 | PV1 | 9 | 60 | XCN | Y | 0010 |
| Contact Address | 01166 | FAC | 7 | 200 | XAD | Y | |
| Contact Person | 01266 | FAC | 5 | 60 | XCN | Y | |
| Contact Person Social Security | 00754 | NK1 | 37 | 16 | ST | | |
| Number | | | | | | | |
| Contact Person's Address | 00750 | NK1 | 32 | 106 | XAD | Y | |
| Contact Person's Name | 00748 | NK1 | 30 | 48 | XPN | Y | |
| Contact Person's Name | 00748 | GT1 | 45 | 48 | XPN | Y | |
| Contact Person's Telephone | 00749 | NK1 | 31 | 40 | XTN | Y | |
| Number | | | | | | | |

The first column of Table III identifies a data element by ELEMENT TYPE while the remaining columns define the element's HL7 attributes. ITEM# is an HL7-specific number that uniquely identifies the data element throughout the HL7 standard. SEG is the HL7 identity of any segments that the data element will occur and SEQ defines the ordinal position of the data element within the identified HL7 segment. The column labeled LEN refers to the maximum number of characters that one occurrence of the data element may occupy within the segment. The length of a field is normative; however, in general practice, it is often negotiated on a vendor-specific basis. The column labeled DT refers to restrictions on the contents of the data field. REP defines whether a field may repeat and if so, the maximum number of repetitions permitted. The column labeled TABLE defines a HL7 table of values for a particular data element. A table defines a list of values for the entity. In this case, the data element. Tables may contain either HL7 or user defined values. Segment types may be required or optional, depending on the message and event types. Segments are identified using a unique segment identifier code (ID). For example, an ADT message may contain Message Header (MSH), Event Type (EVN), Patient ID (PID), and Patient Visit (PVI) segments. Segments may also be proprietary to a vendor and thus identified with segment ID codes beginning with the letter Z. Each HL7 segment consists of a collection of segment fields, or string of characters. Certain segment fields may be required or merely optional within a particular segment depending on the segment identifier code. Segment fields are transmitted as character strings; however, some HL7 segment fields may take on the null value, which is different from an optionally deleted field. For cases where a value for the data element is transmitted, a segment field may contain a data element or might merely be a placeholder within the segment for that data element. The HL7 Standard specification contains segment attribute tables that list and describe data fields within an identified segment and characteristics of their usage. HL7 fields are defined in a comprehensive data field dictionary.

The inclusion of the fields in the message segment may be Required (R), Optional (O), or Not Used (N). Below are some exemplary HL7 message types, along with segment descriptions for each message.

1. Message Type: ACK (General Acknowledgement Originator)—It has 3 segments:

(a) MSH—Message Header (R).

(b) MSA—Message Acknowledgement (R).

(c) ERR—Error Message

2. Message Type: ADT (Admission, Discharge and Transfer)—It has various ADT events associated. For example,

ADT Event Code: A01

Event: ADMIT A PATIENT

Message Segments are:

(a) MSH—Message Header (R).

(b) EVN—Event Type (R).

(c) PID—Patient Identification (R).

(d) NK1—Next of Kin (R).

(e) PV1—Patient Visit (R).

(f) DG1—Diagnosis Information (O).

ADT Event Code: A02

Event: TRANSFER A PATIENT

Message Segments are:

(a) MSH—Message Header (R).

(b) EVN—Event Type (R).

(c) PID—Patient Identification (R).

(d) PV1—Patient Visit (R).

ADT Event Code: A03

Event: DISCHARGE A PATIENT

Message Segments are:

(a) MSH—Message Header (R).

(b) EVN—Event Type (R).

(c) PID—Patient Identification (R).

(d) PV1—Patient Visit (R).

The PID (Patient Identification) segment is used by all ancillary systems' applications as the primary means of communicating patient identification information. This segment contains permanent patient identifying and demographic information that, for the most part, is not likely to change frequently. Therefore, the PID segment must contain non-ambiguous information values that are easily understood across disparate systems. Below is an exemplary table containing segment attributes for a PID segment.

TABLE IV
(PID Segment Attributes)

| Seq | Len | DT | Opt | Rep | Table | Item# | Element Type |
|---|---|---|---|---|---|---|---|
| 1 | 4 | SI | O | | | 00104 | Set ID - PID |
| 2 | 20 | CX | B | | | 00105 | Patient ID |
| 3 | 20 | CX | R | Y | | 00106 | Patient Identifier List |
| 4 | 20 | CX | B | Y | | 00107 | Alternate Patient ID - PID |
| 5 | 48 | XPN | R | Y | | 00108 | Patient Name |
| 6 | 48 | XPN | O | Y | | 00109 | Mother's Maiden Name |
| 7 | 26 | TS | O | | | 00110 | Date/Time of Birth |
| 8 | 1 | IS | O | | 0001 | 00111 | Sex |
| 9 | 48 | XPN | O | Y | | 00112 | Patient Alias |
| 10 | 80 | CE | O | Y | 0005 | 00113 | Race |
| 11 | 106 | XAD | O | Y | | 00114 | Patient Address |
| 12 | 4 | IS | B | | 0289 | 00115 | County Code |
| 13 | 40 | XTN | O | Y | | 00116 | Phone Number - Home |
| 14 | 40 | XTN | O | Y | | 00117 | Phone Number - Business |
| 15 | 60 | CE | O | | 0296 | 00118 | Primary Language |
| 16 | 80 | CE | O | | 0002 | 00119 | Marital Status |
| 17 | 80 | CE | O | | 0006 | 00120 | Religion |
| 18 | 20 | CX | O | | | 00121 | Patient Account Number |
| 19 | 16 | ST | B | | | 00122 | SSN Number - Patient |
| 20 | 25 | DLN | O | | | 00123 | Driver's License Number - |
| | | | | | | | Patient |
| 21 | 20 | CX | O | Y | | 00124 | Mother's Identifier |
| 22 | 80 | CE | O | Y | 0189 | 00125 | Ethnic Group |
| 23 | 60 | ST | O | | | 00126 | Birth Place |
| 24 | 1 | ID | O | | 0136 | 00127 | Multiple Birth Indicator |
| 25 | 2 | NM | O | | | 00128 | Birth Order |
| 26 | 80 | CE | O | Y | 0171 | 00129 | Citizenship |
| 27 | 60 | CE | O | | 0172 | 00130 | Veterans Military Status |
| 28 | 80 | CE | O | | 0212 | 00739 | Nationality |
| 29 | 26 | TS | O | | | 00740 | Patient Death Date and Time |
| 30 | 1 | ID | O | | 0136 | 00741 | Patient Death Indicator |

The PID Segment Attribute Table IV is similar to Table III (HL7 Data Element Types) described above with the additional column labeled OPT that defines whether or not a particular field is required (R), optional (O), conditional in a segment (C), not used with a trigger event (X) or left in for backward compatibility for other HL7 versions (B). Using the above-described HL7 rules, any disparate application can generate an HL7 message. Below is an example of an HL7 admit/visit notification transaction triggered from an A01 event (admitted patient).

MSH|\hat{ }˜\&|ADT1|SWR|LABADT|SWR|198808181126|SECURITY|ADT\hat{ }A01|MSG00001|P|2.3.1|<cr>

EVN|A01|200101030803∥<cr>

PID|1∥PATID1234\hat{ }5\hat{ }M11\hat{ }ADT1\hat{ }MR\hat{ }SWR˜123456789\hat{ }\hat{ }\hat{ }USSSA\hat{ }SS∥

JOHNSON\hat{ }DARRELL\hat{ }A∥19610615|M∥C|1200 N ELM STREET\hat{ }\hat{ }GREENSBORO\hat{ }NC\hat{ }27401-1020|GL|(919)379-1212|(919)271-3434∥S∥

PATID12345001\hat{ }2\hat{ }M10\hat{ }ADT1\hat{ }AN\hat{ }A|123456789|987654\hat{ }NC|<cr>

NK1|1|JONES\hat{ }BARBARA\hat{ }K|WI\hat{ }WIFE∥∥NK\hat{ }NEXT OF KIN<cr>

PV1|1|I|7050\hat{ }7113\hat{ }01∥∥101010\hat{ }SHYNER\hat{ }RALPH\hat{ }J.|∥SUR∥∥ADM|A0-|<cr>

Patient Darrel A. Johnson was admitted on Jan. 03, 2001 at 08:03 a.m. by doctor Ralph J. Shyner (#101010) for surgery (SUR). He has been assigned to room 7113, bed 01 on nursing unit 7050. The message was sent from system ADT1 at the SWR site to system LABADT, also at the SWR site, on the same date as the admission took place, but three minutes after the admit.

Problems, other than at the system level, also developed in the prior art. Enterprise department information products have an additional disadvantage of being system level data images. An enterprise level perspective of an information solution is difficult to achieve because it would be necessary for an enterprise user to understand the data images from all disparate, ancillary system's products that service the enterprise. Finding an enterprise level information solution is problematical because most enterprises rely on their enterprise departments for IS solutions thus, rarely does an enterprise establish an enterprise level information priori.

Aside from problems associated with hierarchical information levels, enterprise users needing to access system level data and functionality must be competent with a variety of disparate, ancillary applications. Any user needing data from a system must be competent with that system in order to utilize the disparate system interfaces for drilling down into individual department data structures. Many enterprise IS personnel are not overly proficient with a variety of disparate, ancillary applications and non-IS enterprise users are even less competent. Therefore, it is often left to the individual enterprise department to provide the necessary skilled IS personnel to interface with enterprise users needing system level data and functionality. Reliance on individual enterprise departments to access their disparate, ancillary systems for responding to enterprise user requests may result in a lag between the enterprise level query and a system level response from a department, as well as increasing the likelihood of a miscommunication between the enterprise user and a department's IS specialist. Maintaining a duplicative force of department IS personnel in each disparate, ancillary system to respond to enterprise users also increases the IS overhead for the disparate enterprise departments.

With respect to the health care services industry, the prior art attempts to solve many of the aforementioned shortcomings by eliminating the disparate, ancillary applications and application databases and utilizing an enterprise level application and application level database. By adopting an enterprise information priori, enterprise departments were forced to gradually migrate their ancillary applications toward the enterprise standard and gradually disband their legacy applications.

Another enterprise level solution, such as is commonly applied in a health care facility, is to receive messages from any one of a plurality of disparate, ancillary vendor applications, convert the vendor information to an enterprise usable form and then store the enterprise information on an enterprise database. The messaging between ancillary systems is through a standardized messaging protocol described above. Messages are generated at an ancillary system in response to an trigger event and sent to other ancillary systems and a data warehouse. Enterprise users are then able to access data at the data warehouse.

### SUMMARY OF THE INVENTION

The present invention provides a means for an enterprise, such as a health care facility, to view information as it resides in the individual disparate system's databases. As information portal is created into all of these systems by connecting one server to all of these data sources and push data to the user via a web browser based on a set of business rules. Dynamically deciding what to display for the user and what not to display would reduce the “time to market” for the data to the user and allow the user to make more intelligent, more accurate conclusions in his/her job. By leaving the data intact and in-place, the cost associated with such an enterprise project is eliminated and its accuracy is guaranteed at the time the user requests the data. The information portal has a database to house profile information about the users; names, departments, phone numbers, pager numbers, etc., and then use this data to build an online “Corporate Directory” for employees to search.

### BRIEF DESCRIPTION OF THE DRAWINGS

The novel features believed characteristic of the invention are set forth in the appended claims. The invention itself, however, as well as an exemplary mode of use, further objectives and advantages thereof, will best be understood by reference to the following detailed description of an illustrative embodiment when read in conjunction with the accompanying drawings, wherein:

The present invention is illustrated by way of example, and not by way of limitation, in the figures of the accompanying drawings and in which like reference numerals indicate similar elements and in which:

FIG. 1 illustrates a prior art application layer messaging between disparate, ancillary systems;

FIG. 2 illustrates the embodiment of security by ownership of content in accordance with an exemplary embodiment of the present invention;

FIG. 3 is a block diagram illustration of the embodiment of direct access to data and disparate systems in accordance with an exemplary embodiment of the present invention;

FIG. 4 is a flowchart depicting the process of signing an electronic document using the Signature Engine application in accordance with an exemplary embodiment of the present invention; and

FIGS. 5-55 are screen shots depicting various aspects of the presentation and use of the present invention.

### DETAILED DESCRIPTION OF THE INVENTION

Some of the problems that spurred the development of the present invention are the existence of very expensive, very powerful legacy applications that are cumbersome to access and deploy. They require bulky software to be installed on each workstation and each has its own security module requiring the user to remember his/her usernames and passwords to all of these different systems. Even if a user masters the fine art of remembering all of these usernames and passwords, his train of thought is broken when he must stop what he is doing in one application and log in to another.

The Conventions

TABLE I
(The Conventions)

Windows NT Server
Microsoft IIS (Internet Information Server) for the web server
SSL (Secured Sockets Layer)
Microsoft ASP (Active Server Pages) for the coding language (JSCRIPT flavor)
ODBC (Open Database Connectivity) for the connection to the databases
ADO (Active Data Objects) for web server connection to ODBC
TMSSequoia ViewDirector Prizm for the browser plug-in to view Medical Records images
Adobe PhotoShop for the graphics creation

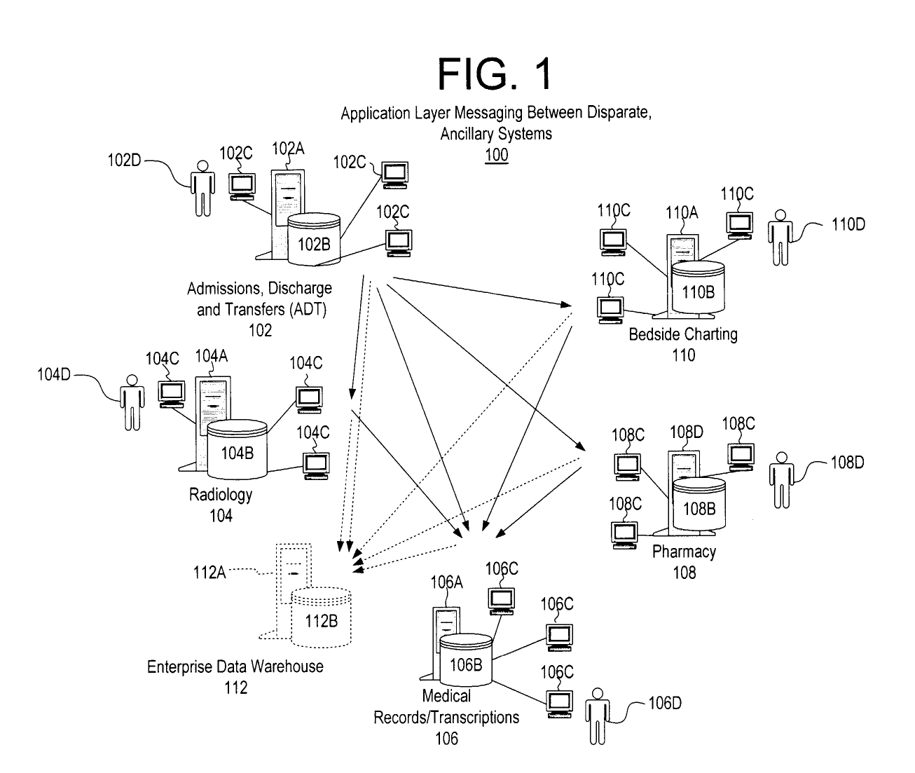

The above-described approach involves “intercepting” and copying messages for use in and from the disparate systems. Another approach involves intercepting messages and copying them to an enterprise data warehouse as depicted in FIG. 1 enterprise data warehouse 110. In accordance with that approach, the warehoused data is then available from a centralized location for access by any authorized users. The problem with each of these approaches is that each data transmission is intercepted and then a copy is created for use in that disparate system or the enterprise data warehouse. Therefore, multiple copies of the data will exist within the enterprise. Multiple copies of a given piece of data in the enterprise creates the possibility for error opening the door for the possibility for old, outdated or simply wrong data to be presented back to the user. Also, data synchronization becomes a problem as data must be updated in each of its multiple locations. Additionally, the cost to the enterprise also increases. The increase in cost is only partially a product of disk array and data storage. When a warehouse of data is created that essentially holds copies of everything in an organization, the cost to the organization is at least doubled over the amount to save the original data and that amount does not take in consideration the increased traffic on the organization's network necessitated by the copying of data into the warehouse. Even if an enterprise is willing to spend the money to do this, reduce the enterprise network bandwidth and the type repository of data could be achieved, there remains the issue of intelligence on the front-end and security. The warehouse cannot know which users need to see what data and when.

Given the existing problems with accessing original data from multiple systems and determining what data was important (personally) for each user to see, the present invention is directed to a mechanism connecting all of these systems logically without having to duplicate the data in the enterprise yet another time. In accordance with an exemplary embodiment of the present invention, a portal is created into all of these systems by connecting one server to all of these data sources and push data to the user via a web browser based on a set of business rules. Dynamically deciding what to display for the user and what not to display would reduce the “time to market” for the data to the user and allow the user to make more intelligent, more accurate conclusions in the user's job. By leaving the data intact and in-place, the cost associated with enterprise warehousing projects is eliminated and data accuracy is guaranteed at the time the user requests it.

In accordance with an exemplary embodiment of the present invention, the “Portal” comprises a database to house profile information about the users, e.g. names, departments, phone numbers, pager numbers, etc. and then use the profile data to build an online “Corporate Directory” for employees to search. The directory utilizes HyperText Markup Language (HTML) for document formatting whereby functional “tags” or “hot links” are embedded in the displayed text. For example, by clicking on the pager number associated with a person listed in the corporate directory, an alpha/numeric page can be sent to that person immediately, without having to make a separate telephone call for a page.

However, data that is present in one of the disparate legacy systems is treated differently from the profile information. Existing data is simply “hooked” and pulled into a user's web browser. The present approach has two advantages: 1) data is displayed to a user that is logically similar to data that exists in different legacy systems; and 2) data is not duplicated for storage. For example, the present invention allows for the display of patient demographics from the Registration System, an admitting diagnoses from the Bedside Charting system and the results of a Laboratory draw from the Lab System—in a logical format and all in the same screen.

### Connectivity Method

Connectivity is provided by any single data interface designed for accessing relational or non-relational databases from multiple database vendors. In accordance with an exemplary embodiment of the present invention, the ActiveX® Data Objects (ADO) programming model, a trademark of and available from Microsoft Corporation in Redmond, Wash., can be used to provide database access to the disparate databases. ADO is a feature of Microsoft Internet Information Server (IIS); however, Data Access Objects (DAO) or Remote Data Objects (RDO), both available from Microsoft Corporation, can be used, though not Universal Data Access (UDO) compliant. The present invention uses the ADO feature of IIS to connect to and pull data from disparate applications relational databases. However, it should be understood that the tables in the disparate databases may not be known and therefore, prior to connecting and reading from the database, the separate database tables should be analyzed. Also required is a vendor application utilizing a relational database that is of an “open” architecture (meaning non-proprietary) and can be connected to using this method. Some relational databases that support an open architecture are SQL Server, Oracle, Sybase, Informix, Access, etc. Otherwise, the proprietary architecture convention for the database must be known or obtained from the database's vendor.

An example of the connection string is:

“Provider=SQLOLEDB.1;Persist Security Info=True;Initial Catalog=DisparateSystemDatabase1;Data Source=DisparateSystem1;Connect Timeout=60;”

Multiple connections may need to be opened at the same to display data from SEVERAL databases on one web page. An example of this would be:

“Provider=SQLOLEDB.1;Persist Security Info=True;Initial Catalog=DisparateSystemDatabase1;Data Source=DisparateSystem1;Connect Timeout=60;”

“Provider=SQLOLEDB.1;Persist Security Info=True;Initial Catalog=DisparateSystemDatabase2;Data Source=DisparateSystem2;Connect Timeout=60;”

“Provider=SQLOLEDB.1;Persist Security Info=True;Initial Catalog=DisparateSystemDatabase3;Data Source=DisparateSystem3;Connect Timeout=60;”

etc . . . .

For each connection that will need to be made throughout the Portal, a session variable is used to call this syntax once and store it to be called later in other pages. This is an example of how to instantiate a session variable for the connection string(s):

“Session(“ConnectionName”)=new String(“Provider=SQLOLEDB.1;Persist Security Info=True;Initial Catalog=DisparateSystemDatabase1;Data Source=DisparateSystem1;Connect Timeout=60;”);”

This, then, can be called throughout any/all pages by using “Session(‘ConnectionName’)” to make a connection to this database. Another way to accomplish this same thing would be to use a constant and store them in an include file to be called from any page for use.

Once the appropriate connection has been established to the disparate system database, an appropriate SQL call would need to be initiated based on the data that needs to be retrieved. An example of such a SQL statement would be:

“SELECT LabVal1, LabVal2, LabVal3

FROM LabsTable

WHERE EncounterNum=‘123456’

AND MedicalRecordNum=‘9876543’”

The data that is returned is stored in a recordset and displayed on the web page as desired using the “Response.Write(RS.fields(n).value)” function (again, all part of the ADO collection). Active Server Pages (“ASP”) is used to determine which SQL statement to run and against which database through programming scripts that utilize if/else logic running from the web server.

```
Below is an example of an ASP script that performs if/else logic:
  if condition1 = value1
  {
```

doThisThing( );
thenDoThatThing( );

```
  }
  else
  {
```

doThisOtherThingInstead( );

}
Each of these “things” are ASP functions that establish connections to the different

disparate databases. An example of an ASP Function would be:

```
  Funcion doThisThing( );
  {
```

DConn = Server.CreateObject(“ADODB.Connection”);
MainRS = Server.CreateObject(“ADODB.RecordSet”);
DConn.Open(Session(“dbserver”), Session(“dbusername”),

Session(“dbpassword”));

DConn.CursorLocation = 3;

}

### The Security Module

To provide this “seamless” approach to displaying information, a flexible and manageable security module has been implemented. This security module is built on the basis that each user belongs to a group. A group belongs to a public group. Each group has at least one “Content Owner.” This person is responsible for uploading and managing the content for their specific group. Each Content Owner has the ability to upload information as “personal” content as well. This means that the information is specific to them personally, not the entire group and can be viewed only by the owner.

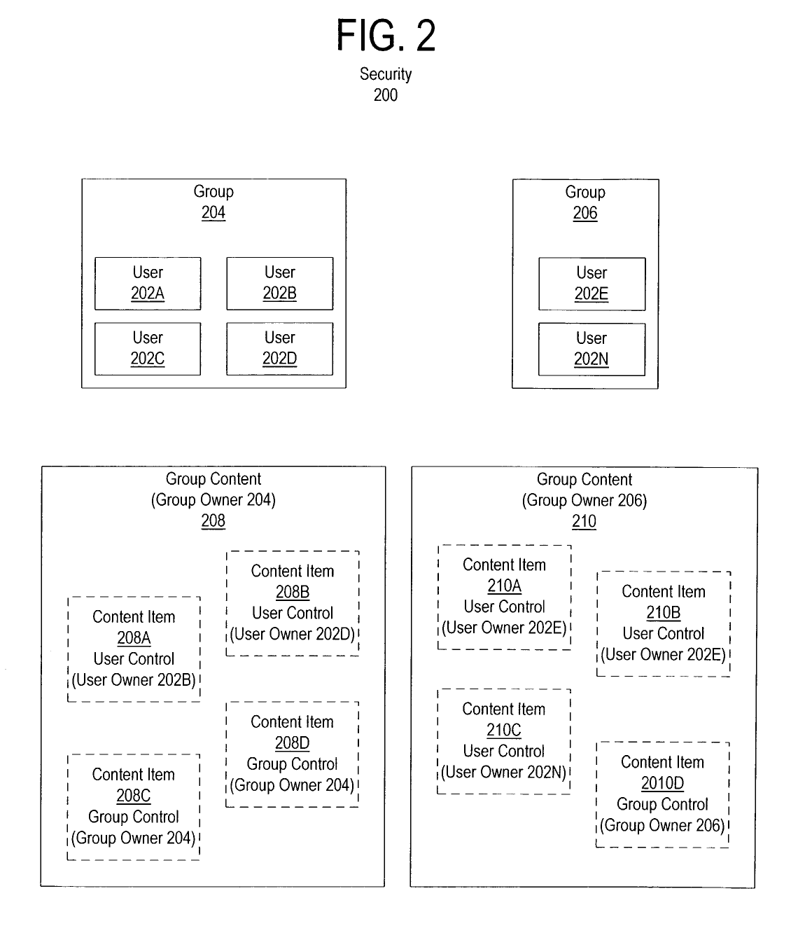

FIG. 2 is diagram of a security module of data ownership in accordance with an exemplary embodiment of the present invention. Security module 200 consists of two user groups 204 and 206, each comprising a plurality of users; users 202A, 202B, 202C, and 202D in group 204 while users 202E and 202N are in group 206. Enterprise content is own by either users or groups that users belong to. In the depicted example, content is owned by members of groups 204 and 206. Content owned by members of group 204 is depicted as group content 208 and the content owned by members of group 206 is depicted as group content 210. However, every member of the group does not necessarily have control content items in the group's content. For instance, content item 208A is owned exclusively by user 202B, while content item 208B is owned exclusively by user 202D. Content items 208C and 208D are owned by the members of group 204. A “Content Owner” is responsible for uploading and managing the content items which belong to the owner. However, the content owner of the public group is responsible for uploading and managing the content for the default information. This information is information of a general nature that all users can see whether or not the user is logged on. Examples include the corporate directory, message board, general information, etc. which are accessible essentially by accessing the enterprise's public web site.

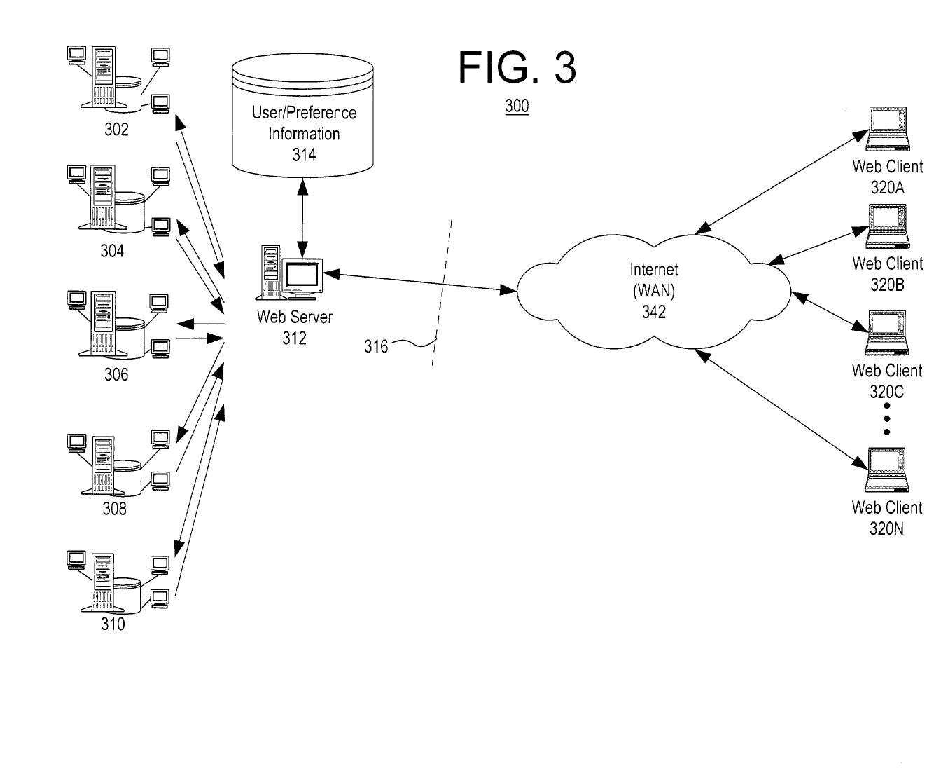

FIG. 3 is a diagram of an enterprise system which includes a plurality of disparate, ancillary systems connected to a “Portal” web server for executing enterprise level message transactions in accordance with an exemplary embodiment of the present invention. In the depicted example, an enterprise network comprises connection and networking means for enabling communications between each of disparate systems 302, 304, 306, 308, 310 and web server 312. Additionally, disparate systems 302, 304, 306, 308 and 310 may be capable of communications directly to one another. Web server 312 is connected to database 314 which contains user and preference information and the security module described above for accessing any database in one of disparate systems 302, 304, 306, 308 and 310. Additionally, web server 312 provides connectivity between web clients 320A-320N and user and preference information stored in database 314 or databases in disparate systems 302, 304, 306, 308 and 310 through a TCP/IP connection across Internet 342, traversing enterprise firewall 316.

As mentioned above, in accordance with an exemplary embodiment of the present invention, database 314 does not capture an image of data residing in any database associated with disparate systems 302, 304, 306, 308 and 310, but instead merely retains information of a general nature that all users can see, including the corporate directory, message board, and other general information available, for instance, on the enterprise's public web site. Database 314 includes all information stored for the Portal including a Hospital registration database.

### Database Structure

In accordance with an exemplary embodiment of the present invention, database 314 utilizes a Structured Query Language (SQL) interactive programming language for retrieving and updating information in the database, for example Windows NT Server running Microsoft SQL Server 7.0 both available from the Microsoft Corporation. Queries to database 314 are structured in a well-known form of a command language for manipulating data as is well known by artisans in the art. Specifically, database 314 of the Portal houses and maintains information that allows the Portal to operate in a customized, personal manner. It contains data about each user, their group, their preferences, what role they play in the organization, what data they need to see, etc. In essence, one could say that the Portal database is a “Meta-data” database. It is not a data warehouse and does not house any data from any legacy system. It does, however, have tables for things like the Portal's “Audit Trail” (which records a footprint of everything done in the Portal) and the “Signature Engine” (the back-end process for electronically signing documents). It is fully relational and easily expanded upon. Table VI below is an exemplary table schema for database 314 in accordance with an exemplary embodiment of the present invention.

TABLE VI
(Table Schema)

| AuditTrail | Chat | Groups | Items |
|---|---|---|---|
| Action | AlreadyHer | Facility | DateAdded |
| ActionDate | Message | GroupDesc | GroupID |
| UserID | MessageID | GroupID | HTMLText |
| | Ringing | | ItemDesc |
| | RoomID | | itemdesclo |
| | UserName | | ItemID |
| | | | Keywords |
| | | | Path |
| | | | SearchOnly |
| | | | UserID |
| | | | WhoAdded |
| MessageBoard | Policies | PolicySignOff | ReferenceList |
| Facility | PolicyDesc | DateSigned | Active |
| Line1 | PolicyID | PolicyID | ReferenceDesc |
| Line2 | PolicyText | UserID | ReferenceID |
| Line3 | | | ReferenceURL |
| Line4 | | | |
| Line5 | | | |
| Line6 | | | |
| Line7 | | | |
| MessageID | | | |
| Title | | | |
| ReferencePicks | Users | ePage | UserAliases |
| ReferenceID | Active | Message | userid1 |
| UserID | DefaultCensus | PageDate | userid2 |
| | ViewDepartment | PageFrom | |
| | EmailAddress | PageID | |
| | Extension | PagerNumber | |
| | Fax | Subject | |
| | FirstName | | |
| | GroupID | | |
| | IsContentOwner | | |
| | LastName | | |
| | MiddleName | | |
| | Pager | | |
| | PagerType | | |
| | Password | | |
| | Phone | | |
| | PhysicianCode | | |
| | Title | | |
| | UserID | | |
| | UserName | | |

| Covering | SignEngine | HelpDesk |
|---|---|---|
| UserID1 | DateTimeStamp | CALL_ID |
| UserID2 | Facility | CONTACT_TYPE |
| | LogicalPath | EMAIL_AD- |
| | | DRESS |
| | PhysicalPath | IP_ADDRESS |
| | PhysicianCode | MESSAGE |
| | Rect_H | ResponseBy |
| | Rect_T | STATUS |
| | Rect_W | SUBJECT |
| | Rect_X | TIMESTAMP |
| | Rect_Y | USER_ID |
| | SignatureID | |
| | SignText | |
| | Status | |

### Clinical View

The decision of what the default view for a particular user is decided by the users personal profile. The default view for any Clinician (Physician, PA/PE, MA, Resident, etc.) is the “Clinical View.” This view displays information like Current Census, Medical Record Chart Completion (electronic dictation and signature), Workflow queue access, Patient Record Search, Medical Staff Bylaws, etc. that are accessible to the generally public.

For displaying the census list for the user, a connection is made, the appropriate SQL Statement is made to the Hospital registration database, and the data is returned to the screen for the user in a useable format (as described above). Each patient name has a convenient hypertext link which allows authorized users to drill down on that particular patient and see real-time Bedside Charting, Radiology Results, Laboratory Results and Medical Records for that patient. Each of the disparate systems are connected to and data is pulled in the same manner as described above. Where discrete, numerical values are presented, the Clinician can click on the value and see a graph, trending all of the results for that patient for that particular test. Also provided are hypertext links to popular Internet web sites that will assist a clinician in treating the patient. With one click, the user can research a particular drug or catch up on the latest research on his patient's condition.

The Electronic Medical Record is connected to in the manner described above to provide the “Medical Record” to the user. All charts for this patient are displayed in this module. The user has the ability to view the patient's record by encounter number (visit) or by document name. The user can also search all textual documents for a specific keyword or phrase. Example: if the clinician wishes to see if this patient has ever had any history of high blood pressure, he would simply type “hypertension” in the search box provided. The Portal then goes out to all of the charts for that patient and searches through all of the text documents for that particular word. It then returns back the name/page of each instance where this occurs.

The Portal does this by sending a parameter (the Medical Record Number) to a SQL stored procedure (stored in the Portal database). The stored procedure collects all pointers to all pages of all charts for that patient. It then performs a Bulk Copy Program (“BCP”) function (native to SQL Server) which imports all of the individual rows from all text documents into a temporary table. Then the stored procedure searches the rows of the temporary table (now containing all of the lines from all of the text documents for this patient) for any existence of the word “hypertension.” Lastly, it returns the document name/page number and physical address of each of the files in which that word was found.

Below is exemplary procedure code for searching disparate databases which is stored in database 314, the Portal database.

CREATE procedure searchcold (@username char(30), @mrn char(20),
@keyword varchar(255))
AS
SET NOCOUNT on
DECLARE @imnet char(30)
DECLARE @path varchar(255)
DECLARE @VarBCPCMD varchar(255)
DECLARE @dir char(60)
DECLARE @subdir char(10)
DECLARE @file char(10)
DECLARE @volume char(20)
DECLARE @frame char(20)
DECLARE @frame1 char(10)
DECLARE @frame2 char(10)
-- Find all cold files for this patient, spanning all encounters--
DECLARE cur1 SCROLL CURSOR
FOR
SELECT DISTINCT imnet
FROM cabinet. .cabinet
WHERE filename = ‘CLD’
AND document NOT IN (‘GRAPHIC CHARTS’, ‘MODIFY/INACTIVATE REPORT’,
‘NURSING NOTES/DATA’, ‘TEACHING/INSTRUCTIONS’, ‘ASSESSMENTS’)
AND mrn = @mrn
BEGIN
OPEN cur1
FETCH NEXT FROM cur1 INTO @imnet
WHILE (@@FETCH_STATUS <> −1)

BEGIN
-- Apply algorithm to get the file path from retrieved IMNET

value

select @volume = substring(@imnet,1,9)
select @frame = substring(@imnet,11,6)
select @dir = vol_addr from eiwdata. .eiwt_volume where vol_name =

@volume

select @frame1 = convert (char(10), convert(int,@frame) / 200)
select @frame2 = convert (char(10), convert(int,@frame) −

convert(int,@frame1) * 200)

select @path = rtrim(@dir)+‘\’+rtrim(@frame1)+‘\’+rtrim(@frame2)
-- BCP the file to coldtemp, copy line by line to coldtemp
SELECT @VarBCPCMD = “bcp parsing. .coldtemp in ” + @path + “ /f

\\mrmc_EIW_SERVER\images\bcp.fmt /U crw /P /S mrmc_eiw_server”

exec master. .xp_cmdshell @VarBCPCMD
-- look for the phrase in that page and insert into searchresults

table if it does

if exists (select * from parsing. .coldtemp where line like

@keyword)

begin
if not exists (select * from parsing. .searchresults where

username = @username and mrn = @mrn and imnet = @imnet)

begin
insert into searchresults
values (@username, @mrn, @imnet)
end

end

DELETE FROM parsing. .coldtemp
FETCH NEXT FROM cur1 INTO @imnet
END

CLOSE cur1
DEALLOCATE cur1
END

Alternatively, another method by which one could accomplish this same task is to run the documents through a context search engine. This strips out all of the words in an indexing fashion and the document in context while still making those thoughts and ideas (or phrases and expressions) searchable. As a practical matter, one exemplary embodiment of the present invention uses a more literal approach i.e., it looks for a literal string within the documents.

### Signature Engine

As a matter of normal routine, clinicians dictate their medical diagnosis and findings which are then transcribed into document form, authenticated by the clinician and approved by signing the document. Transcribed documents are often scanned and stored on the medical records and transcriptions system database for downloading and printing. After the clinician signs the document, it is sent via intra-office mail back to medical records, rescanned and stored.

The Signature Engine is an application that allows physicians to electronically sign scanned documents through the portal. Scanned documents generally reside on a database in the medical records and transcriptions disparate system, for instance one of disparate systems 302, 304, 306, 308 and 310 depicted in FIG. 3. The SignEngine table is populated with information needed to create an electronic signature for an image document. Table VI below is a representative SignEngine table in accordance with an exemplary embodiment of the present invention.

TABLE VII
(SignEngine Table)

| Field | Description |
|---|---|
| SignatureID | unique ID generated by the database |
| LogicalPath | the logical path |
| PhysicalPath | the physical path of where the .tif file is located |
| DateTimeStamp | the date and time of when the physician clicked on the sign button |
| SignText | the physician full name and title |
| PhysicianCode | physician number that signed the document |
| Facility | the facility the signature is for |
| Rect_X | Coordinates of where the text annotation should go |
| Rect_Y | Coordinates of where the text annotation should go |
| Rect_W | the width of the text |
| Rect_H | the height of the text |
| Status | status of signing the document |
| | R = ready to be signed |
| | E = error in signing the file, file was not signed |

Notice that the SignEngine table contains fields for all document specific information for a signature including document location, signing text, ID of the signatory, and information describing how the signature text is to be “burned” onto the document image. Burning the clinician's “signature” on the document image is accomplished by an image editor. An exemplary image editor application is capable of editing images of the particular format type used for storing the document images. For example, the Wang (Kodak) ImageEdit and ImageAdmin API controls that ship with the Microsoft operating systems to manipulate the image formats such as .TIF or .TIFF (Tag Image File Format) image, .BMP (BitMaP) and .GIF (Graphics Interchange Format). As a practical matter, the .TIFF format has become the defacto standard for document images. The clinician's “signature” need not be an electronic reproduction of the actual image but may instead be a text annotation identifying the clinician and the date and time of the signing. Alternatively, an electronic image of the clinician's signature may be burned into the document image on command.

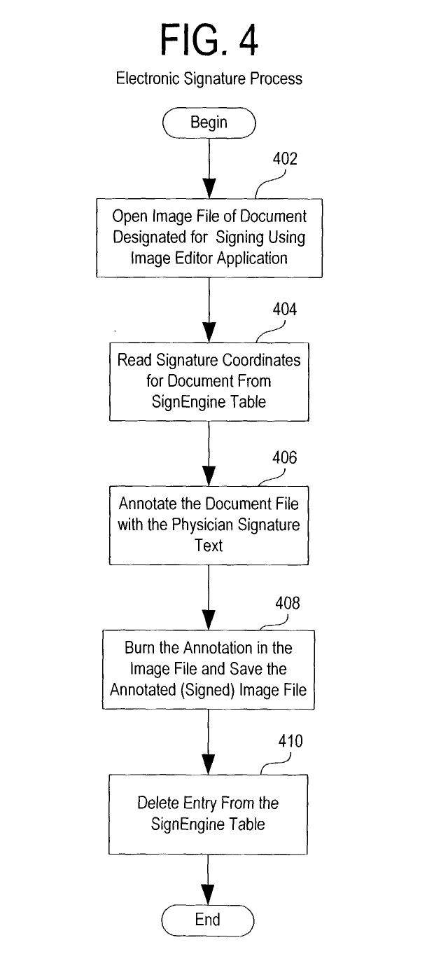

FIG. 4 is a flowchart depicting the process of signing an electronic document using the Signature Engine application in accordance with an exemplary embodiment of the present invention. The process begins with a clinician selecting an image document which is opened using an appropriate image editor for the document file (step 402). The act of selecting the document identifies the clinician to the Signature Engine. Of course, only users authorized to view a document are granted access to view the document and only those authorized users with signatory authority are granted permission by the Signature Engine to sign a document. Next, the information in the SignEngine table is retrieved for the document and the signature size and coordinate information read (step 404). In response to a command from a user with signatory authority, the Signature Engine annotates the document file with the text that represents a physician signature (step 406). An exemplary physician signature consists of “Authenticated by:” <Physician full name> “On” <Date/Time>. The SignEngine table is updated with the date/time stamp for the signing and the identity of the signatory and then saved with the signed document file or, alternatively, pertinent signing information is saved in the document header. Once the file has been annotated, the document image is likewise annotated by burning the signing information into the document image at the prescribed location (step 408). The annotated document image is then saved and the document entry for the signed is deleted from the SignEngine table (step 410).

### Getting Started

The clinical portal information application of the present invention provides enterprise-wide Intranet/Internet access to electronic medical and business record information. This application provides authorized physicians, nurses and other caregivers with easy access to the following information: Patient Census; Outpatient List; Emergency List; In-Patient's Chart; Bedside Chart; Radiology Results; Laboratory Results; Transcription Documents; Search Patient Medical Record; Search Specific Documents; View Chart Deficiencies; Complete Chart Deficiencies; Physician Dictation; e-Sign Transcription Documents; Virtual Help Desk; and View Medical Staff Documents.

The Portal of the present invention utilizes information from a hospital's existing electronic medical record system including laboratory, radiology, medical records transcription, as well as scanned documents from the patient's electronic medical chart. The Portal accumulates information from disparate systems and provides caregivers with a single point, easy-to-use access tool to all relevant patient data captured from multiple encounters, systems and platforms. The portal of the present invention is flexible enough to allow authorized physicians to share information “across the continuum of patient care” to the benefit of patients and providers, while significantly reducing the need for duplicate testing by different physicians and specialists.

Practicing the present invention may be better understood from the following description of the figures depicting screen shots of a typical routine for Practitioner preparing for morning rounds. Initially, Practitioner may access any of the above described data merely by connecting to the Internet using a PC, handheld, PDA, palmtop, Blackberry, or any other net appliance capable of communicating over the Internet. Initially, Practitioner logs onto the Healthcare Institution's web site Portal.

### Logging On and Printing the Patient Census

Practitioner turns on a PC and accesses the Internet using a conventional browser such as Netscape 6.2 available from Netscape Communications Corporation in Mountain View, Calif., Internet Explorer 6.0 available from Microsoft Corporation, or AOL available from America on Line, New York, N.Y. Logging on from outside the hospital, Practitioner types in the URL or Web Location e.g., http://portal.mclaren.org in the location box.. If Practitioner is using a PC within the hospital, Practitioner opens a web browser and types a reference location for the Portal on the hospital's intranet e.g., “Portal” in the location box.

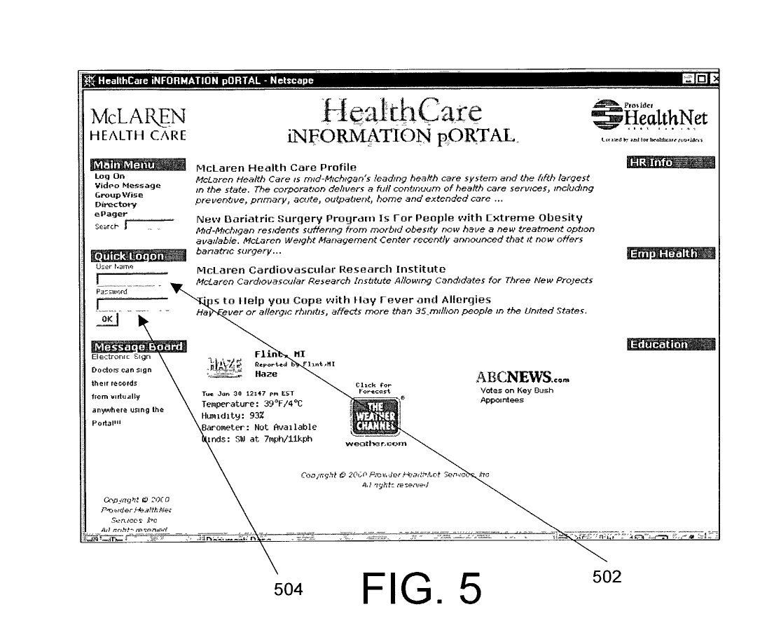

In response, the enterprise page of the hospital will open on the web browser similar to the exemplary page depicted in FIG. 5. The enterprise page contains general information such as current weather, the news headlines and the public Message Board. To log on, Practitioner clicks his left mouse button in User Name: 502 box and types in a unique User Name, which may be the same as used for the Electronic Medical Record system (EMR). Practitioner presses ENTER or TAB and types in the user password that Practitioner uses for his EMR account in User Password: 504. Practitioner presses ENTER to complete the Log On.

It should be understood that a single user may have privileges at multiple healthcare facilities and, a single IT facility supports more than one facility in which as users has privileges, then it is possible that the user will be assigned unique user names for each facility. For example, at LRH healthcare facility the Practitioner enters: Dr Last name, first initial (Dr Jones, A), however for the RMC healthcare facility the Practitioner enters: Last name First name (Jones Alan). Moreover, it is possible to log on to multiple facilities simultaneously, therefore if a physician practices at MRMC and LRH, the way the physician logs on to the portal determines which census list will be displayed first. For example, if the log on is the one used at MRMC, the census will show the list for patients at MRMC and then the list of patients at LRH.

If Practitioner forgets his password, Practitioner can call or contact the Help Desk at the telephone number in the Directory information portion of the web page.

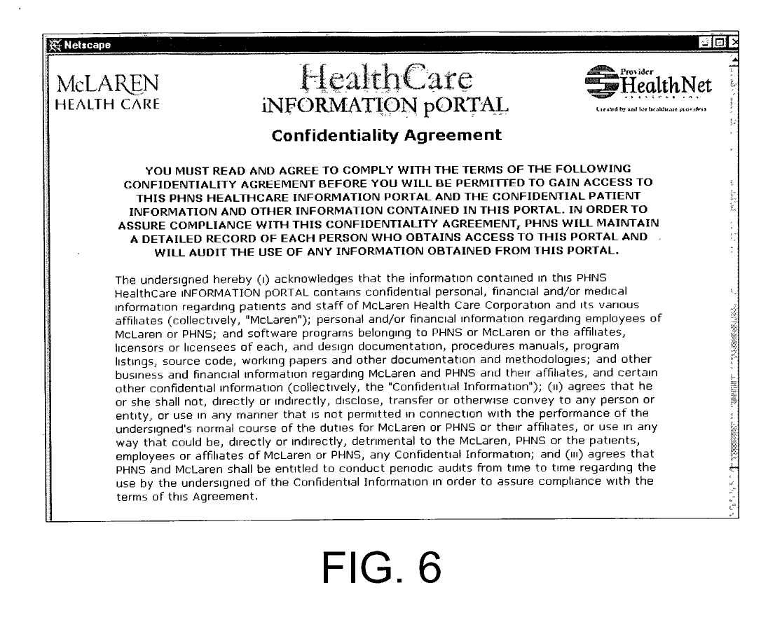

FIG. 6 is a screen shot of an exemplary “Confidentiality Notice” displayed immediately after the log in screen. After reading the notice describing hospital confidentiality requirements, Practitioner scrolls to the bottom of the page (not shown) and clicks the button, I AGREE, before continuing logging on. Ordinary this page will appear only after the initial log in for each user or whenever the institution's confidentiality policies change.

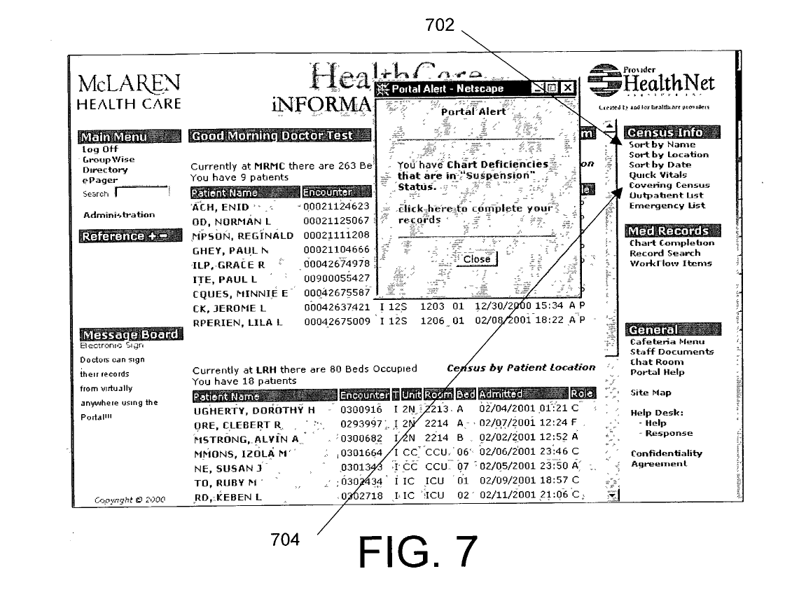

The home page is displayed with Practitioner's current patient census listed by Location (healthcare institution) depicted in FIG. 7. Also notice that an Alert box that tells Practitioner has some chart deficiencies that are in “Suspension” Status. Practitioner can click to go directly to those records using the features of the Alert box or Practitioner can click on Close to close the box and examine the charts at another time. Practitioner can also re-sort his patients by Name, Date of Admission and in the Quick Vitals 702 view (these options are located in the right hand column under Census Info). When Practitioner is covering for another physician, Practitioner can also get that patient listing by clicking Covering Census 704 (also located in the right hand column under Census Info).

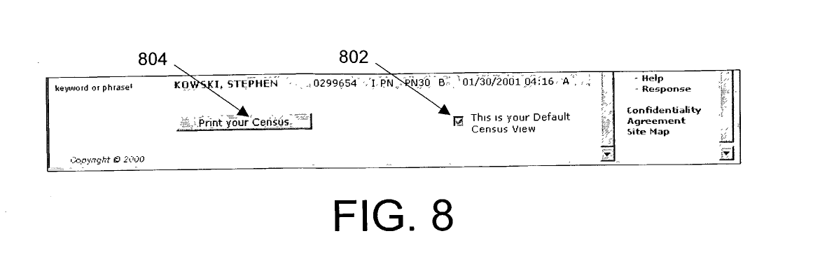

Practitioner can change the default view of the sort order by putting the census listing in the order that Practitioner prefers, scrolling to the bottom of the census list and clicking in the check box labeled This is your Default Census View 802 depicted in FIG. 8.

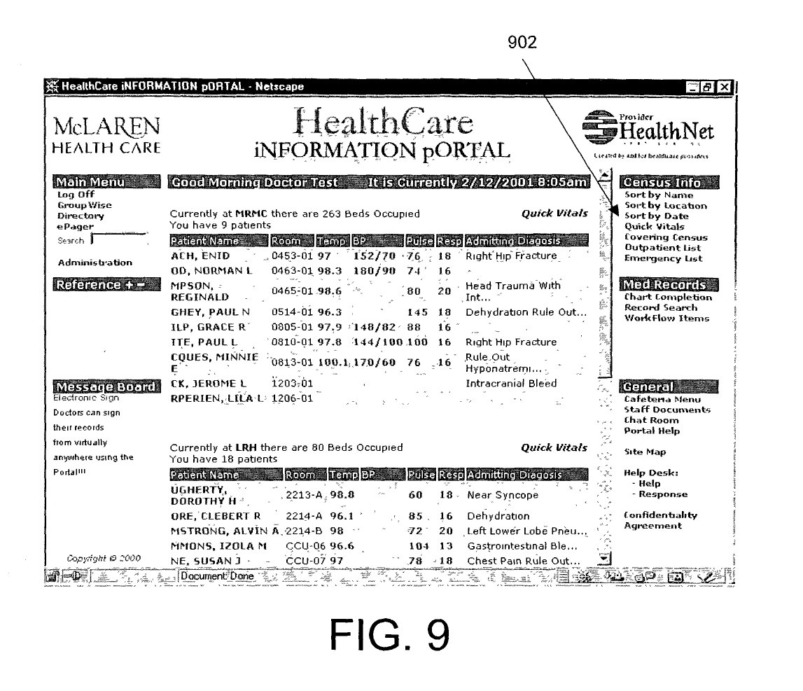

If Practitioner prefers his Census list in the Quick Vitals view 902 depicted in FIG. 9, then Practitioner scrolls to the bottom of the list and clicks on the Print your Census button 804 to print it out as depicted in FIG. 8. Practitioner may also checks the other Census options while Practitioner is here. Practitioner checks the Outpatient List and Emergency List from the home page to see if any of his patients used either service in the past three days.

### Viewing and Printing Outpatient Lists

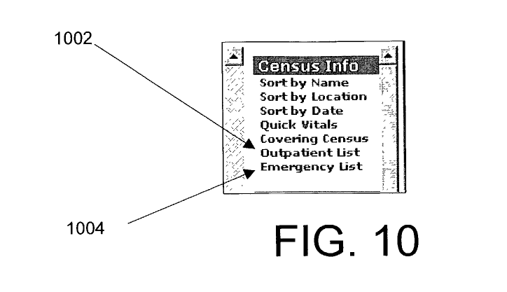

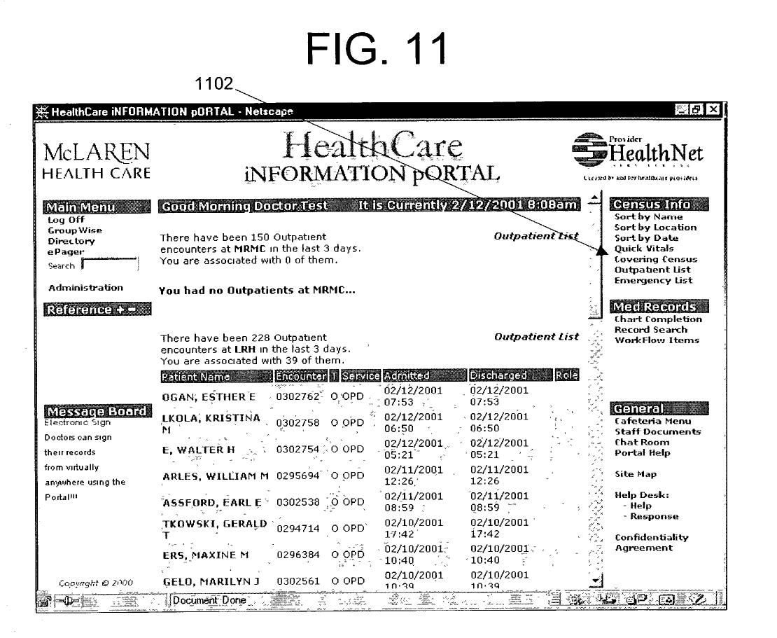

To see a list of his outpatients, Practitioner clicks on Outpatient List 1002 in the right hand column under Census Info as shown in the magnified view in FIG. 10. In response, the outpatient lists for both healthcare facilities are displayed as depicted in the exemplary screen shot shown in FIG. 11. Notice that several of Practitioner's patients have utilized Outpatient Services at LRH, so Practitioner scrolls to the bottom of the list and again clicks on the Print your Census button 804 to print it out as depicted in FIG. 8.

### Viewing and Printing Emergency Lists

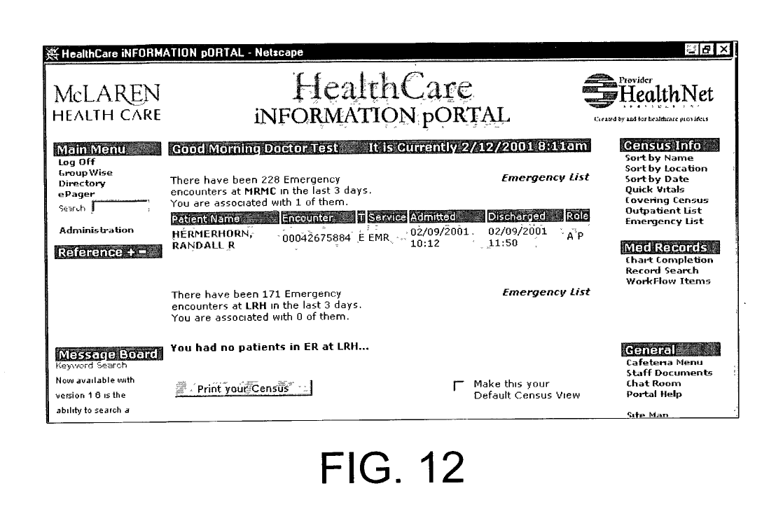

Viewing and printing the emergency lists is essentially the same procedure as discussed above for viewing and printing outpatient lists. Practitioner clicks on Emergency List 1002 in the right hand column under Census Info as shown in the magnified view in FIG. 10. Practitioner checks his Emergency List, shown in FIG. 12, Practitioner sees that one patient went to the Emergency Department at MRMC who was later discharged.

Practitioner then clicks on Covering Census 1102 under Census Info to verify that Practitioner had not been given permission to see other physician's patients.

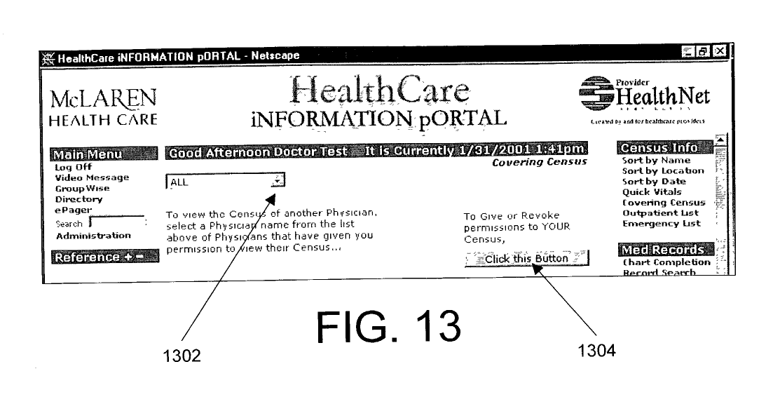

When Practitioner clicks on drop down arrow 1302 depicted in FIG. 13, Practitioner sees that there are no physician names so Practitioner knows that Practitioner cannot see another physician's census list. On this screen Practitioner Give or Revoke permission to other physician for viewing Practitioner's Census information by clicking button 1304. Practitioner can now decides whether or not to view more information on some of his patients displayed o the census list. He has a patient scheduled for surgery this morning so

### Viewing a Patient's Bedside Chart

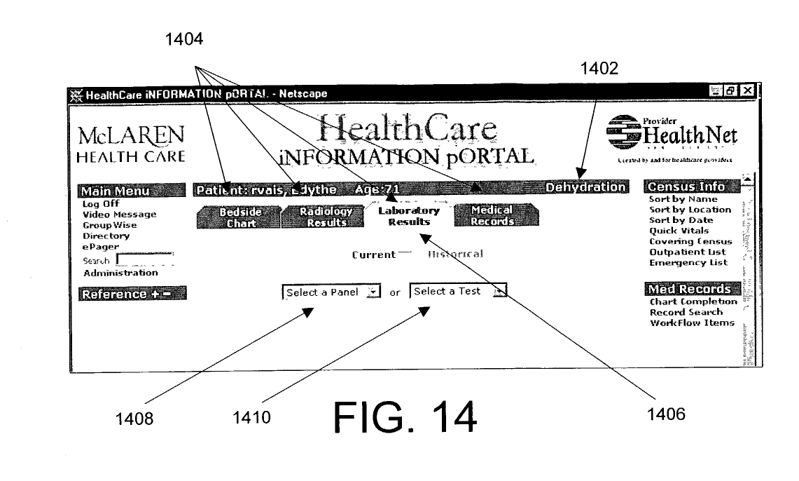

From the Census List displayed on the Home Page, Practitioner clicks a patient's name and the current lab data is ready for selection as shown on FIG. 14. As mentioned above, certain information displayed using the present invention is hot linked to related information in order that a physician or other professional has easy access to all pertinent data, especially for a patient. The information is displayed in a clear logical manner. Notice data bar 1402 at the top of the results list with the Patient Name and Age and Admitting diagnosis. Practitioner looks at the four options (1404) from which to choose: Bedside Chart, Radiology Results, Laboratory Results and Medical Records.

When Practitioner clicks on the Laboratory Results 1406, Practitioner notices that the Laboratory Results tab 1406 is highlighted (turns white). Now Practitioner can narrow the display of information by making a selection from one of the drop-down list boxes, Select a Panel 1408 or Select a Test 1410. Data matching his criteria will be displayed for all information charted in the Care Manager system during this admission.

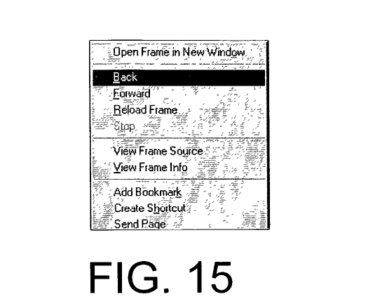

Similarly, if Practitioner clicks on the Bedside Chart tab, that tab is highlighted (not shown). Now Practitioner can narrow the display of information by making a selection from one of the drop-down list boxes, Select a Class or Select a Test (not shown). If information is not currently because the patient has only just been admitted. In that case, Practitioner gets the message, “Sorry, no results . . . ”. To get back to the previous screen, Practitioner will right-click his mouse with the pointer anywhere on the screen and is presented with a browser control popup box similar to that depicted in FIG. 15. Then Practitioner clicks the Back option on the popup box and is returned to the previous screen.

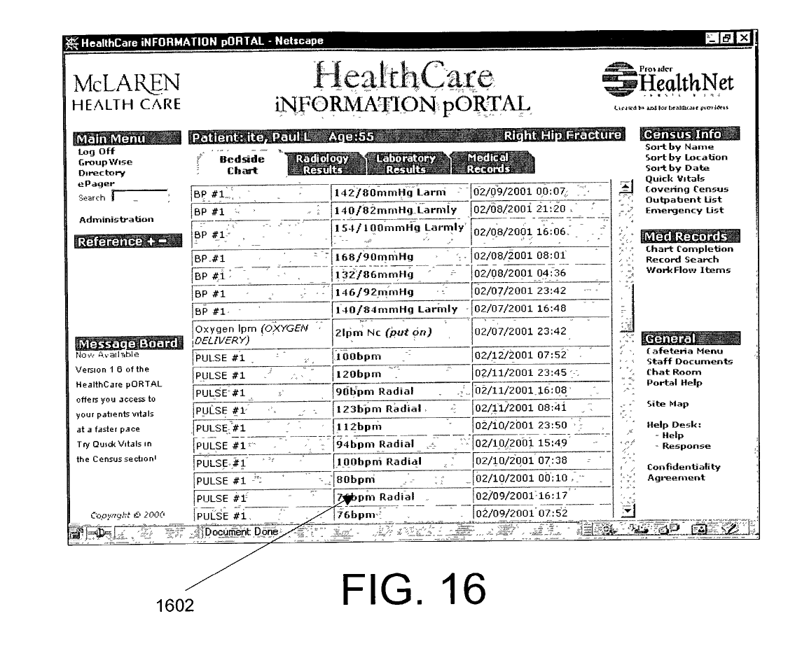

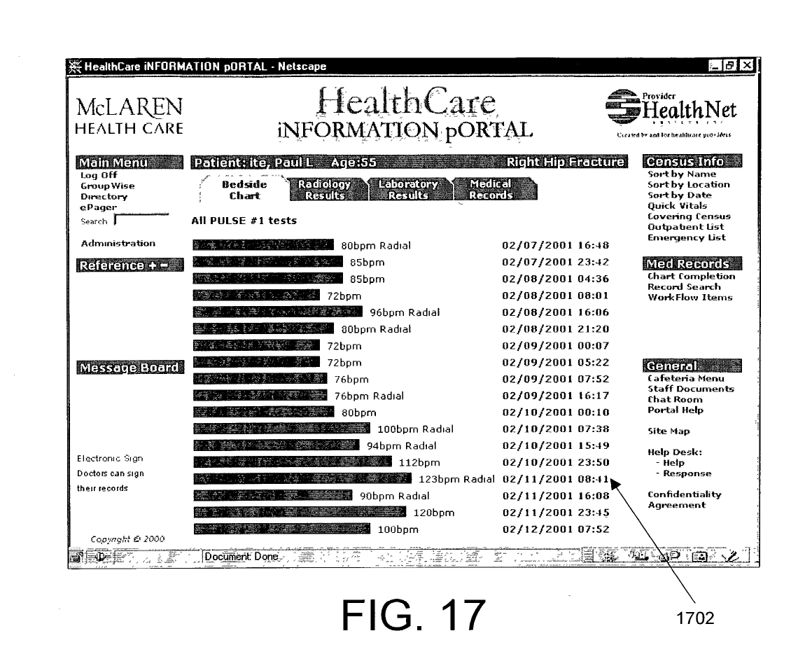

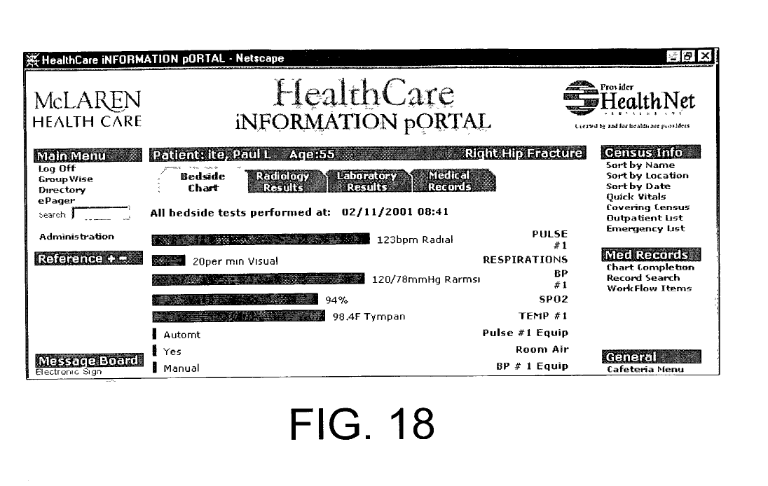

FIG. 16 is a screenshot of an exemplary screen displaying all Vital Sign information for the period that the bedside chart information was collected. After scrolling through the Vital Signs, Practitioner wants to see more detailed information on the patient's pulse. Practitioner clicks on a PULSE value 1602 and in response graphic display of pulse measurements is presents as depicted on FIG. 17 for comparing the pulse values for the period the chart information was collected during this encounter. Practitioner notices the variations at different times of the day. Practitioner then clicks date 1702 (Feb. 11, 2001) to view other bedside chart information recorded for that date and time. Here again, each date is a link to additional information associates with the pulse measurement for that date and the particular patient. Normally, linked text is displayed in a color other than black to give the user a visual clue. Practitioner clicked on the date Feb. 11, 2001 08:41 for the results presented in the screenshot depicted in FIG. 18:

### Viewing a Patient's Radiology Results

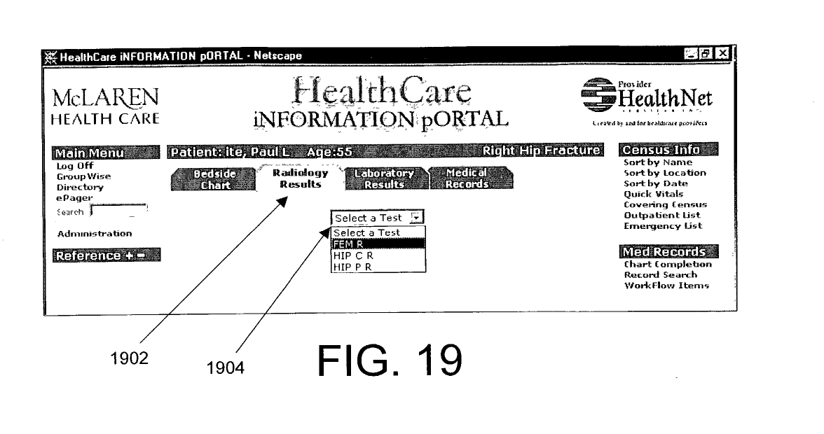

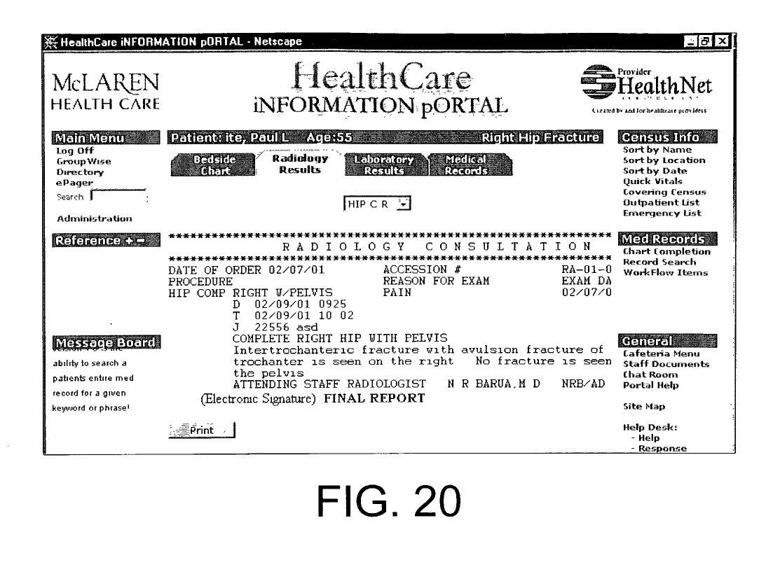

Practitioner clicks on the Radiology tab 1902 as shown in FIG. 19. In the Select a Test drop down box 1904, the tests that were performed on this patient are listed. Practitioner selects the Hip C R (Hip Complete right) to review and is presented with a Radiology Consultation report similar to the screenshot depicted in FIG. 20.

### Viewing a Patient's Lab Results

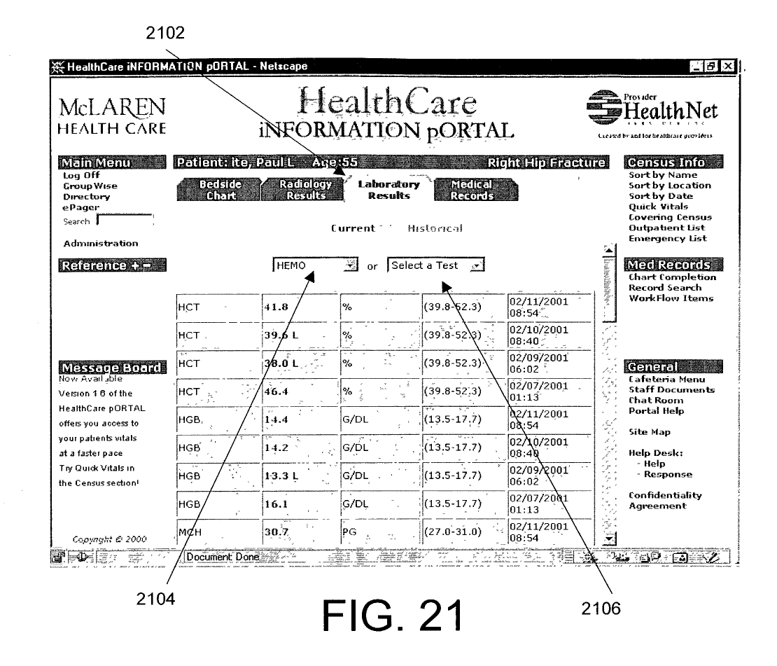

From here Practitioner can click the Laboratory Results tab 2102 shown in FIG. 21 in the data bar at the top of the results list. To narrow the search Practitioner can pick from either Select a Panel 2104 or Select a Test 2106. Practitioner clicks on the drop down arrow for Select a Panel 2104 and selects the HEMO panel. The abnormal values are displayed in red for easy identification.

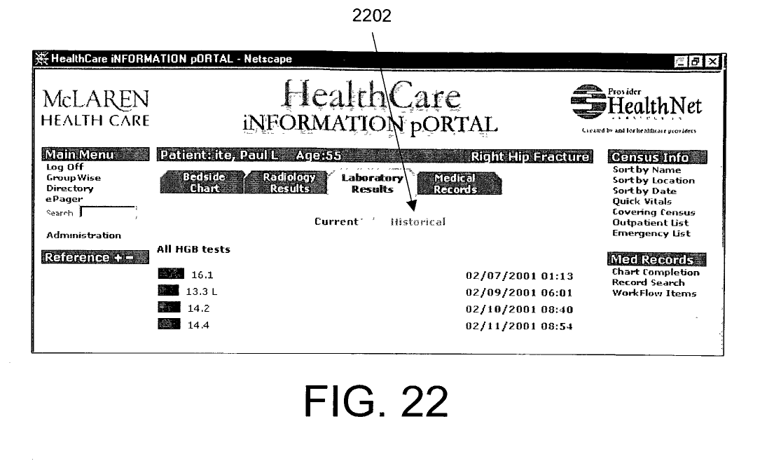

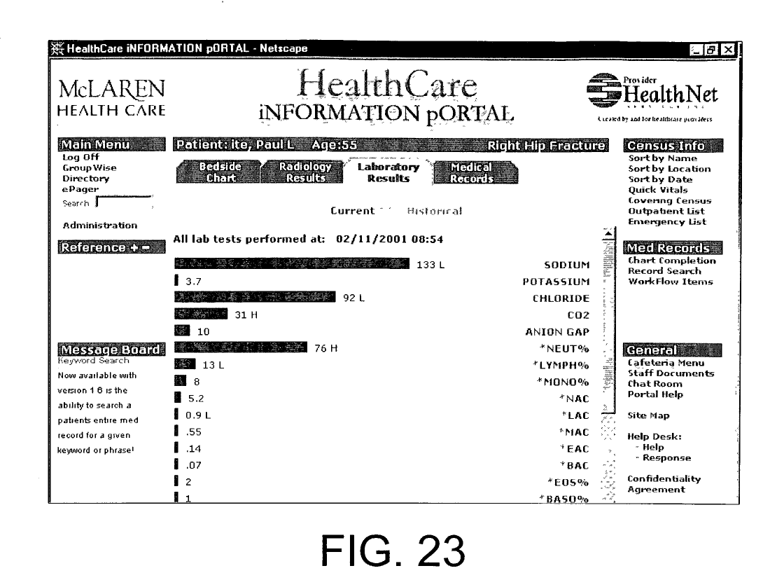

Historical Laboratory results are obtained by clicking on the Historical text 2202 and the practitioner is presented with laboratory data from prior encounters as shown in FIG. 22. Practitioner has several options, scrolling through the data and clicking on a low HGB value to generate a graph or clicking on a date and see other test results that were obtained at that time. FIG. 23 is an screenshot of an exemplary laboratory result in response to clicking on the date “Feb. 11, 2001 08:54.” Practitioner can now review all of the lab results obtained at that time and Practitioner can click on a test to drill down to specific details.

### Viewing a Patient's Medical Record

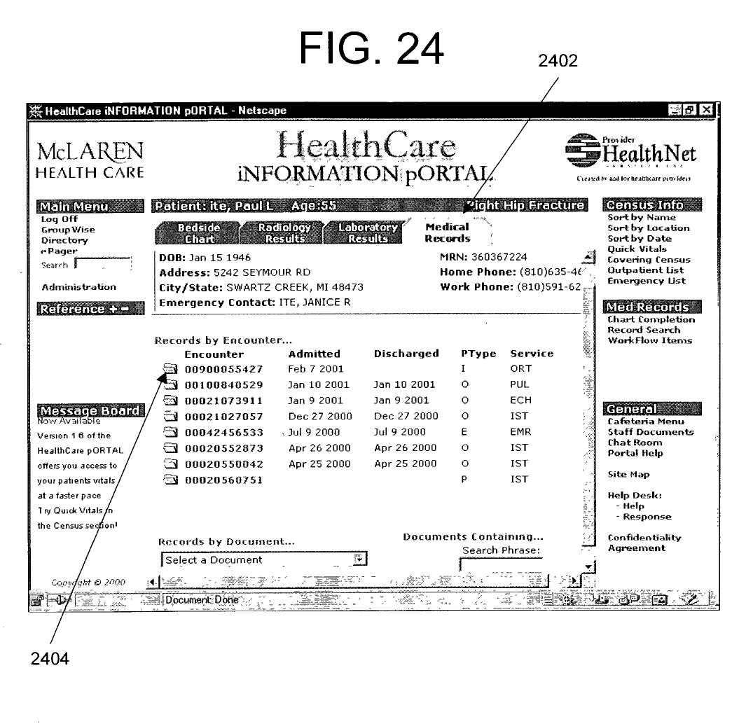

At this point, Practitioner clicks on the Medical Records tab 2402 of the patient screen in the screen shot depicted in FIG. 24. Notice this screen provides demographic data in addition to a list of all patient encounters at this facility.

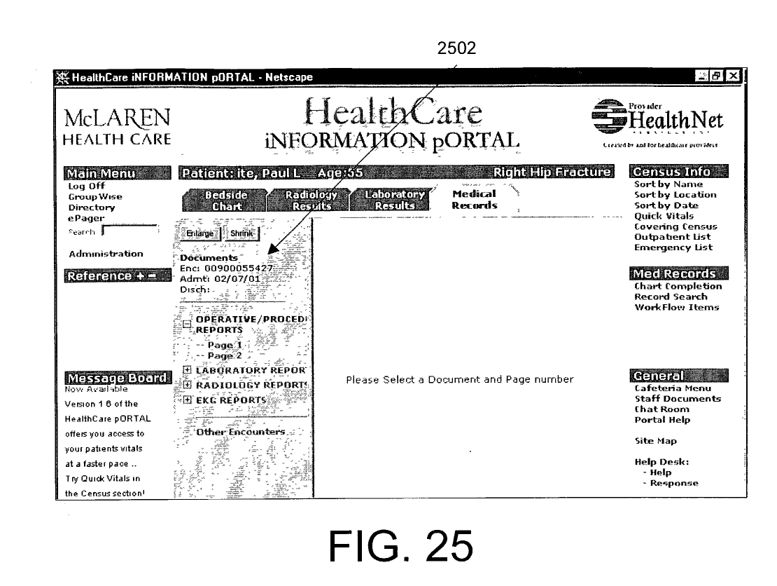

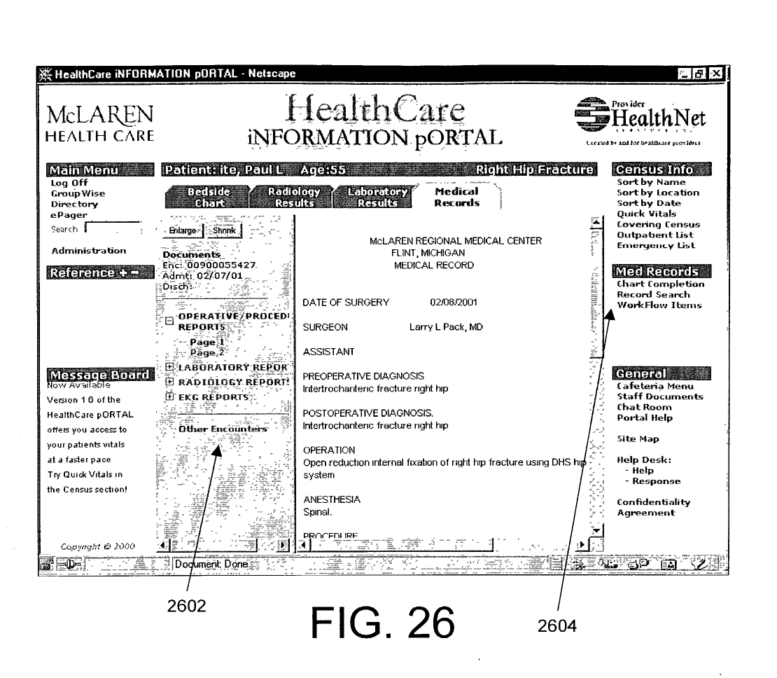

Practitioner clicks on the current Encounter number (2404) so Practitioner can view documents available with this admission. Practitioner is then presented with a listing all of the documents available for the current Encounter as depicted in FIG. 25. From here, Practitioner can select the reports that Practitioner wants to see. Practitioner clicks on a document name (2502) to open the associated document and then clicks on the page number to see each page. Selected documents are highlighted in red. Reports may be presented in a full screen view by clicking n the ENLARGE button and returned to the other options by clicking on the SHRINK button

Practitioner wants to review the Operative/Procedure Reports that was dictated by the surgeon. Practitioner clicks on Page 1 and begins to review it. Practitioner decides to click on the Enlarge button to expand the page to the full screen and make it easier to read. Practitioner can click and view other documents, as well. Practitioner can also click “Other Encounters” 2602, located at the end of the list of documents, and that would take him back to the list of encounters for this patient. Additionally, Practitioner can check the patient's family history to see if there is any relevant information that will help him with this case.

### Searching for a Patient's Medical Record

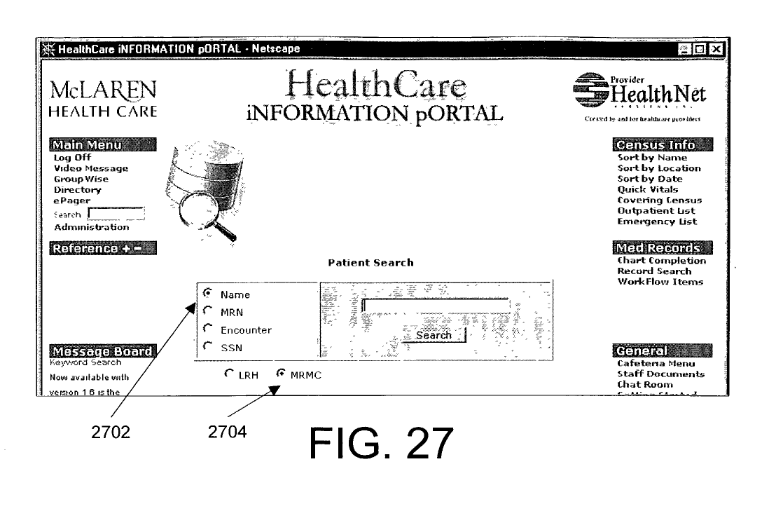

In order to check the patient's family history, Practitioner now clicks on Record Search 2604 under the Med Records title. Using the last name as the search criteria, Practitioner can pull up the chart for any hospitalization at this facility. A patient search dialog box is displayed similar to the screenshot depicted in FIG. 27. Practitioner identifies his search by clicking the radio button 2702 next to Name. Practitioner chooses MRMC 2704 as the facility to search because this family lives in the area of the facility.

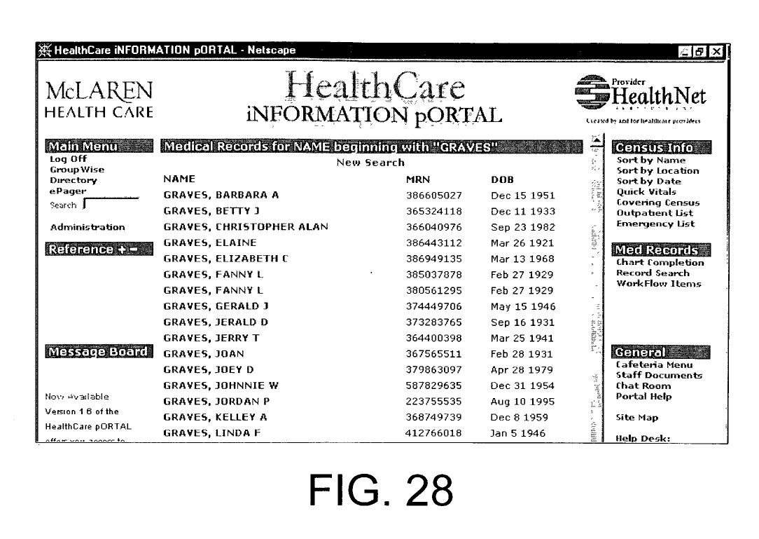

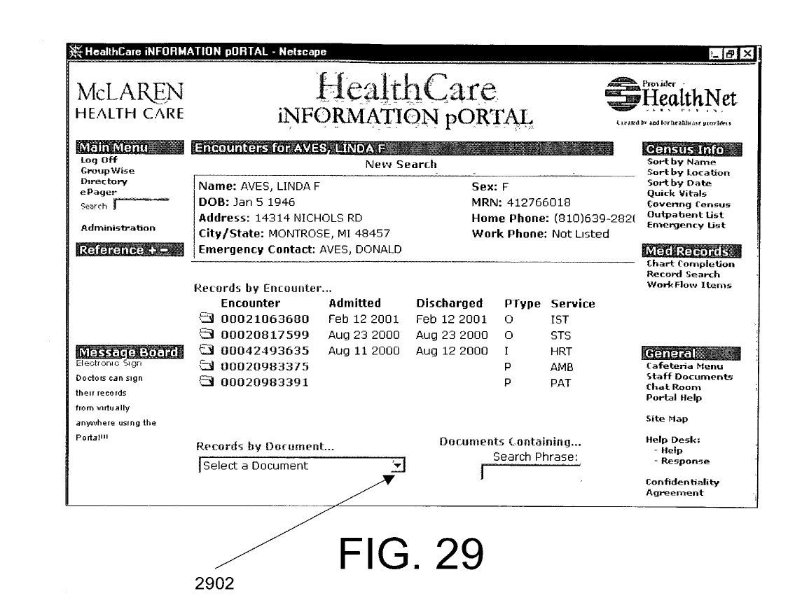

A patient search under the name of “Graves” is performed by typing in the name and presses ENTER. The patient search results are presented similar to those depicted in FIG. 28. Practitioner scrolls down to the exact patient name “Graves, Linda F.” and then clicks the name to select it and the patient results are presented similar to those depicted in FIG. 29. Now Practitioner can open a specific encounter or Practitioner can use the Search feature to find specific lab tests, radiology results, consult reports, documents that Practitioner dictated, etc.

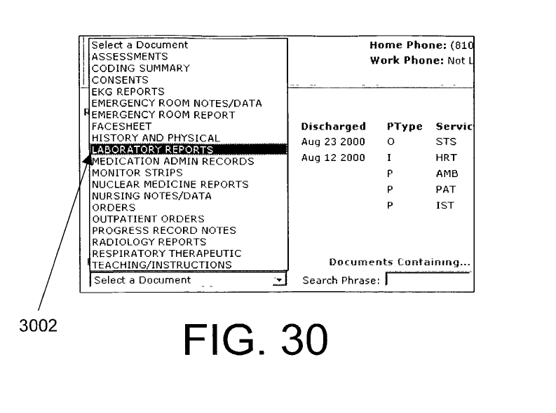

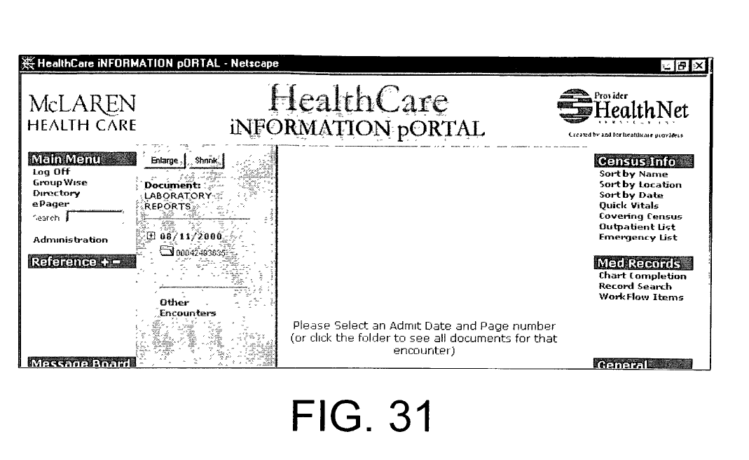

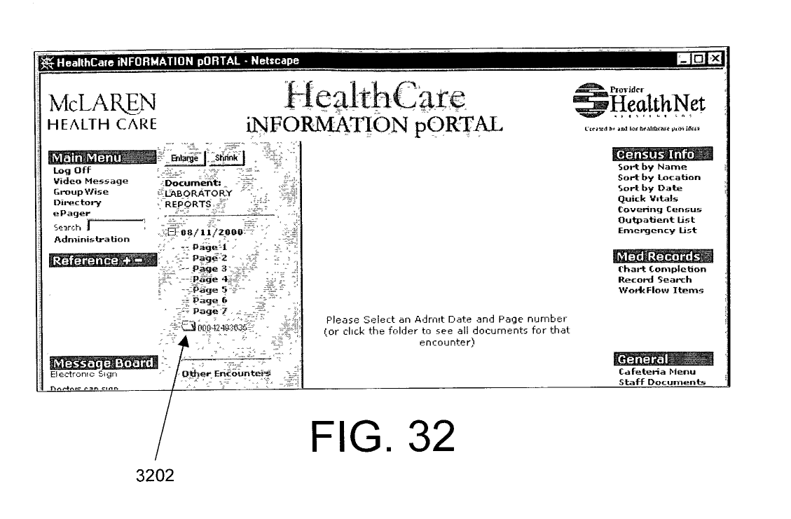

To search by Select a Document, Practitioner clicked on the drop down arrow 2902 and highlighted the document that Practitioner wanted to see (depicted in FIG. 30). The present invention will automatically search all of the encounters for this patient and bring up all of the documents that matched his selection. He decides to review Laboratory Reports of Linda F. Graves and clicks on Laboratory Reports 3002 in the scrolling menu and is presented similar to those depicted in FIG. 31. The list opens with the encounter(s) that have Laboratory Reports in them. To view the reports, Practitioner clicks on the date or the + sign, then clicks on the page that Practitioner wants to read. Practitioner remembers to use the Enlarge button to enhance his view. A − sign shows that the document is open and the date will be highlighted in Red.

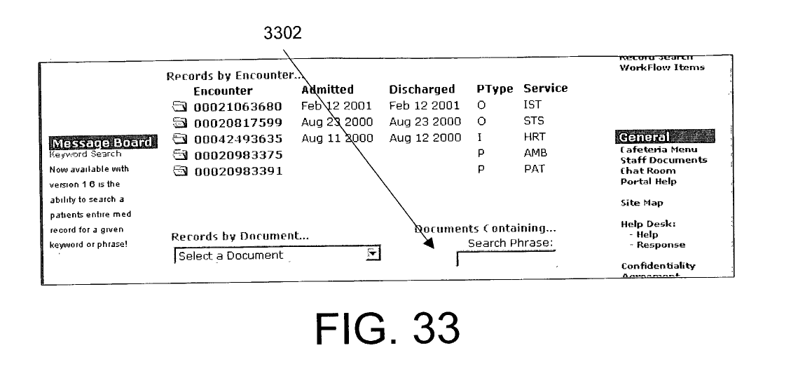

If Practitioner wants to see the entire chart containing this Laboratory Report, Practitioner just clicks on the Folder icon 3202. Upon opening the folder, practitioner notices that she had several lab tests during this admission. Practitioner only wants to see her BUN and Creatinine so Practitioner clicks on Other Encounters and goes back to the Encounter list and uses the Search Phrase function 3302 depicted in FIG. 33.

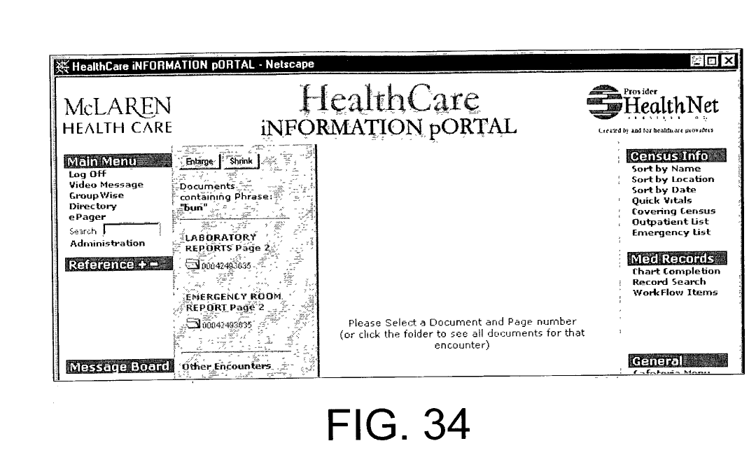

Practitioner enters “bun” in the Search Phrase box 3302 and presses ENTER and is presented with a list of documents that contain the word “bun.” A document is opened by clicking on the document name and the page containing the search word or phrase is displayed (FIG. 34).

The document page that Practitioner is reviewing is highlighted in Red. To view the whole chart that contains that document page, Practitioner clicks on the folder icon. Practitioner will then be able to see all of the documents for that encounter.

### View Practitioner's Chart Deficiencies

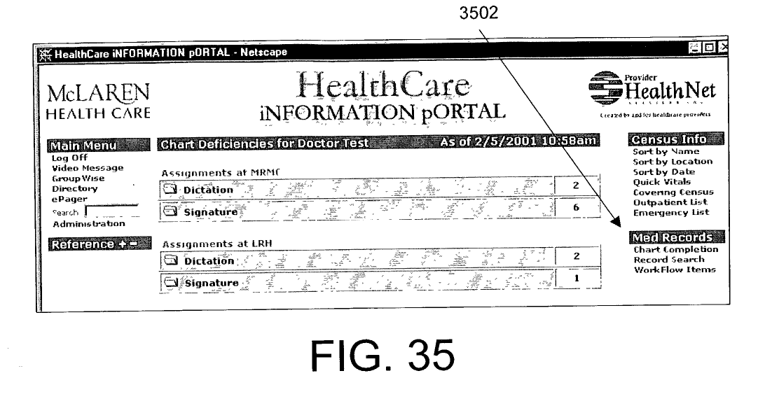

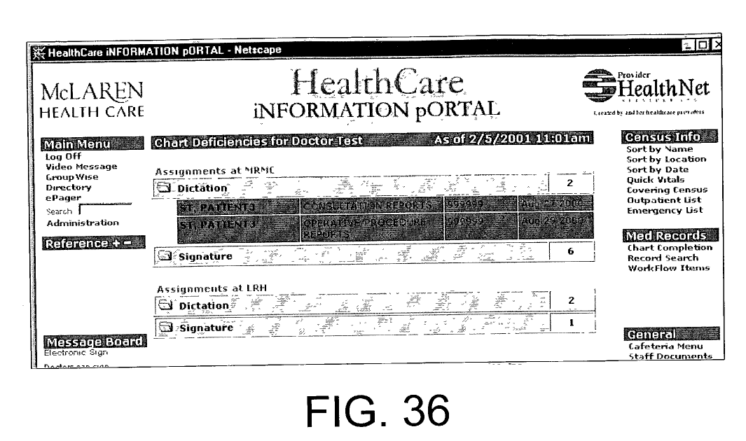

Practitioner checks for chart deficiencies by clicking on Chart Completion 3502 from any screen in the Portal. Practitioner is shown how many records that Practitioner needs to sign and how many charts that still need his dictation as depicted in FIG. 35. By clicking on the Folder or the word Dictation, Practitioner is presented with a list of his charts. Practitioner then selects the record to dictate on by clicking on the patient's name.

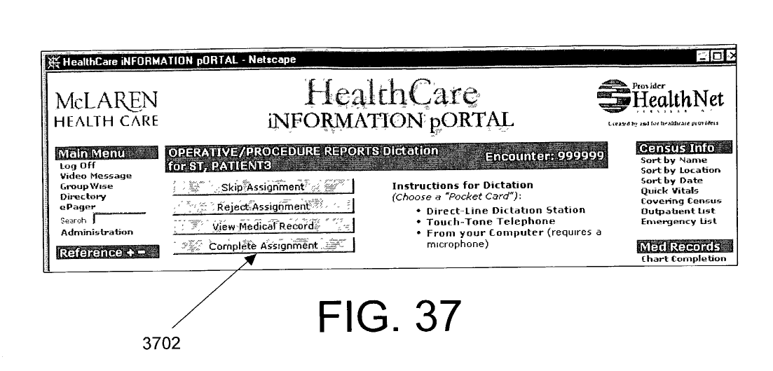

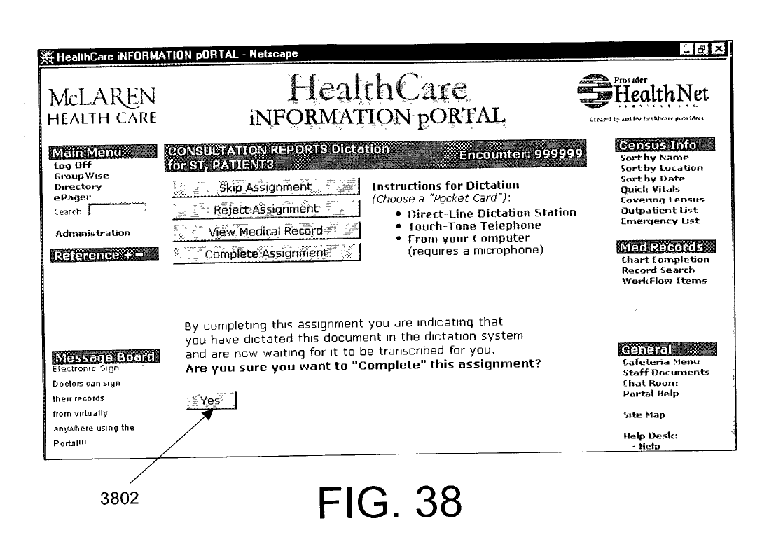

Practitioner can choose to Skip Assignment, Reject Assignment, View Medical Record or Complete Assignment buttons shown in the screenshot depicted on FIG. 37. When Practitioner finishes his dictation, Practitioner clicks on Complete Assignment 3702. Practitioner then sees the message depicted in FIG. 38 asking him to validate that this dictation is complete. If Practitioner is satisfied that Practitioner is through with this dictation, the Yes button 3802 is clicked. If not, then Practitioner can click on any other option on the page, or Practitioner can click the right-mouse button and choose the back option to return to the previous page. When Practitioner clicks on Yes button 3802 for completion of the dictation, that record is removed from his list and the Practitioner can proceed to the next record.

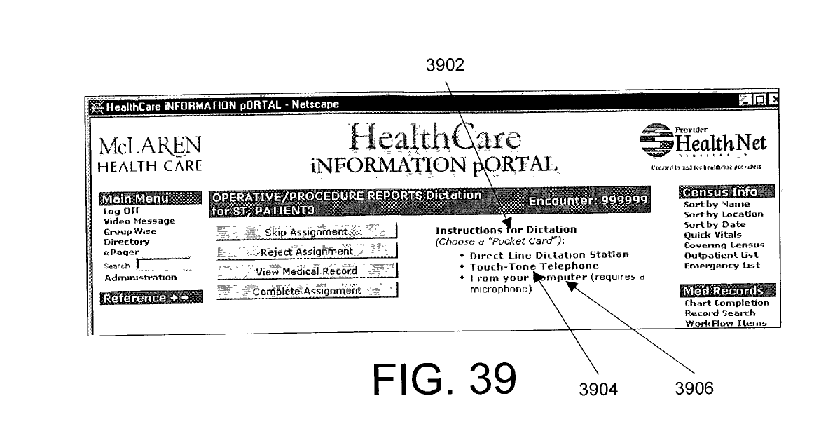

Practitioner notices there is a Help Area called Instructions for Dictation 3902 shown in the screenshot depicted on FIG. 39.

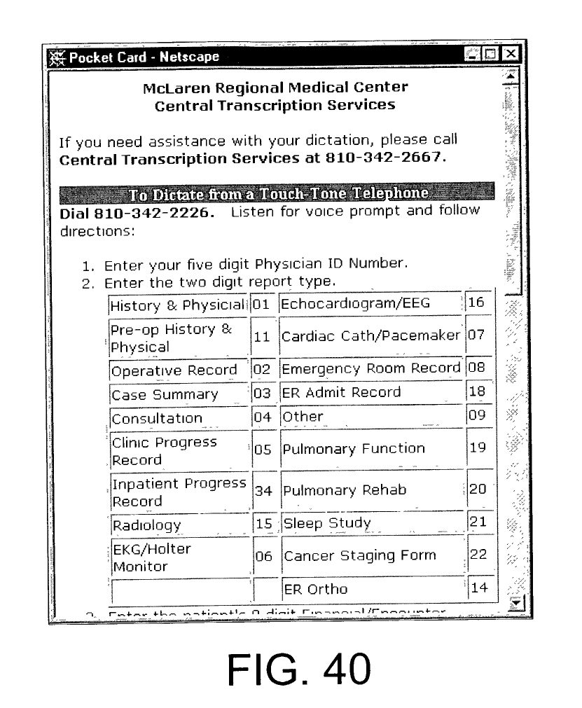

Although Practitioner is familiar with the dictation system, Practitioner clicks on the Touch-Tone Telephone option 3904 to view the Help Card. In response, the window depicted in FIG. 40 opens with instructions on how to dictate his reports from a touch tone phone. Thus, the present invention enables a practitioner to complete dictation tasks from virtually any touch-tone telephone. Additionally, as depicted on FIG. 39, Practitioner may select the topic, From your Computer 3906 for receiving information on using a computer for dictating records. It tells him Practitioner needs a microphone installed on his computer and that there are web sites that Practitioner can subscribe to for phone access.

### Signing Documents

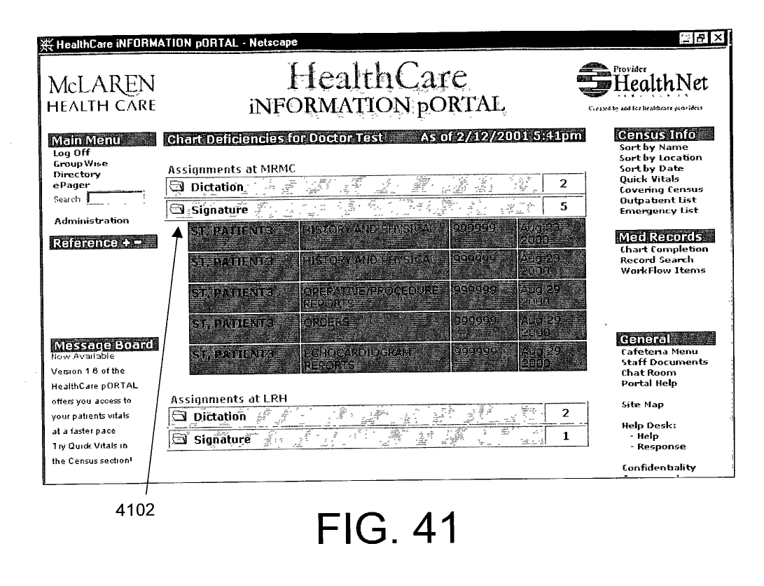

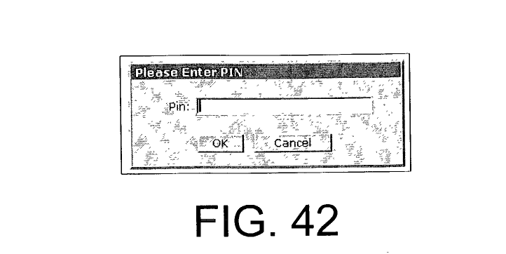

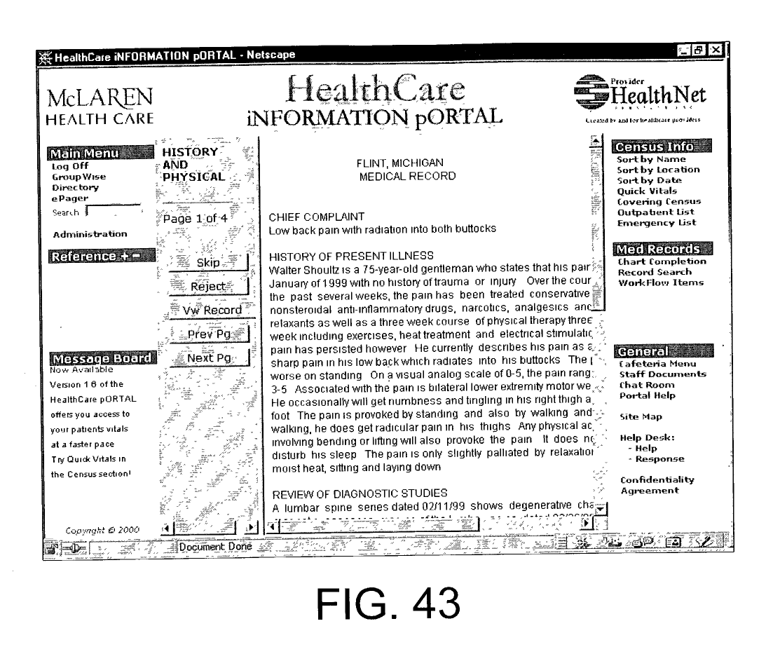

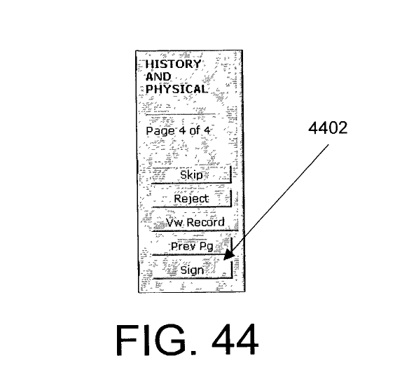

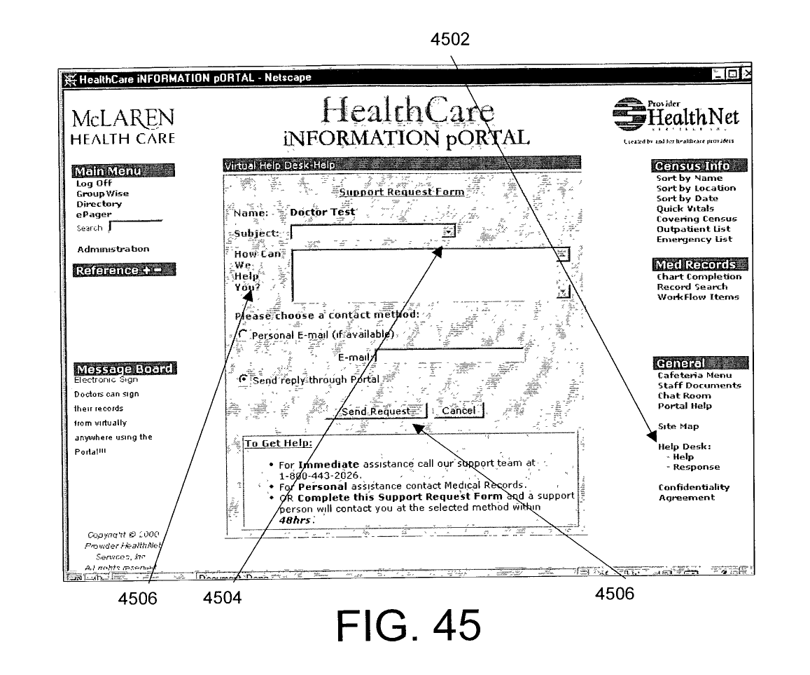

Initially, Practitioner clicks on the folder 4102 or the word Signature to see a list of documents to be authenticated. In accordance with one exemplary embodiment, a time-based color scheme, similar to the EMR color scheme, is used to signify the amount of time since the report has been ready for his signature. Whenever a patient's name is clicked on, for reviewing and signing the History and Physical report that was dictated by the Practitioner. In response, a window is opened asking for a PIN number as shown in FIG. 42. Upon the entry of a valid PIN, which identifies who Practitioner is and validates his electronic signature, the specified record comes up for Practitioner to review ad sign as depicted in FIG. 43. As Practitioner does in the EMR system, Practitioner reviews the page, then clicks on the Next Pg button to go to the next page. The History and Physical document displayed in FIG. 43 has 4 pages that Practitioner reviews before signing the document. When Practitioner gets to the last page, the Next Pg button turns into a Sign button depicted on FIG. 44. Signing is accomplished by clicking on the Sign button 4402 and the document is sent. Practitioner is returned to the list of other documents to sign depicted on FIG. 41 but now displays one less document.

### Using the Virtual Help Desk

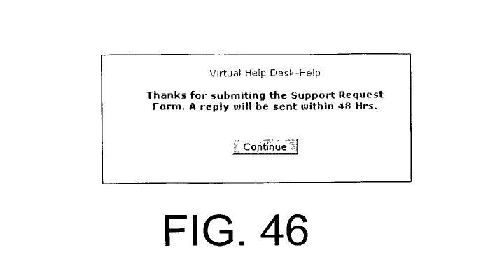

Contact the Help Desk is accomplished by clicking on the Help Desk-Help 4502, you will get the following screen. Immediate help is available by calling the Help Desk at the listed telephone number or a less important question can be answered by messaging the query by clicking on the arrow 4504 by the Subject box and select the subject of your question. Type your question in the How can we help you? Box 4506. Answers are returned via E-Mail, by including an E-mail address, or by clicking on Help Desk-Response. The query is sent by clicking Send Request 4508 and the Help Desk will receive your question. A response window opens verifying that the Help Desk has received the query (FIG. 46).

### Viewing Medical Staff Documents

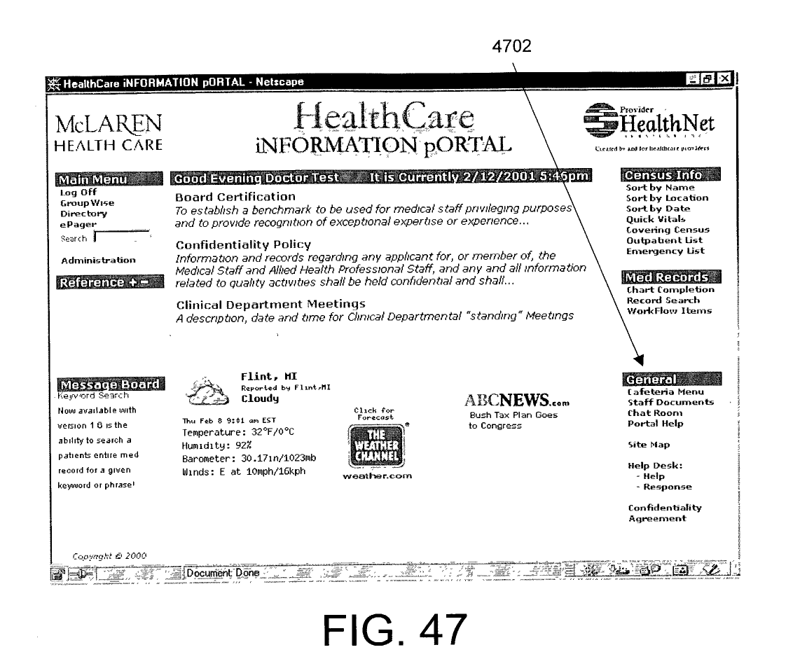

Clicking Staff Documents from the current screen will enable a physician to view all documents that have been added for viewing by physicians only. It's located on the right-hand column under General 4702 depicted on FIG. 47. These include Medical Staff by-laws, Board Certification Policies and Procedures, meeting schedules and other documents pertinent to the physician community.

### Using the Physicians' Chat Room

Practitioner can click the physicians' Chat Room from any screen in the Portal. First Practitioner notices the ChatMaster announced his presence in the chat room. The message says that ‘Doctor Test’ has entered the room. (That's the logon name Practitioner used). He types a message in the scrollable dialog box. Practitioner notices that Practitioner can clear the message and start again, by just clicking Clear, then typing a new message. Practitioner clicks Submit your Text when he's ready. Now Practitioner notices his message displayed in the chat room.

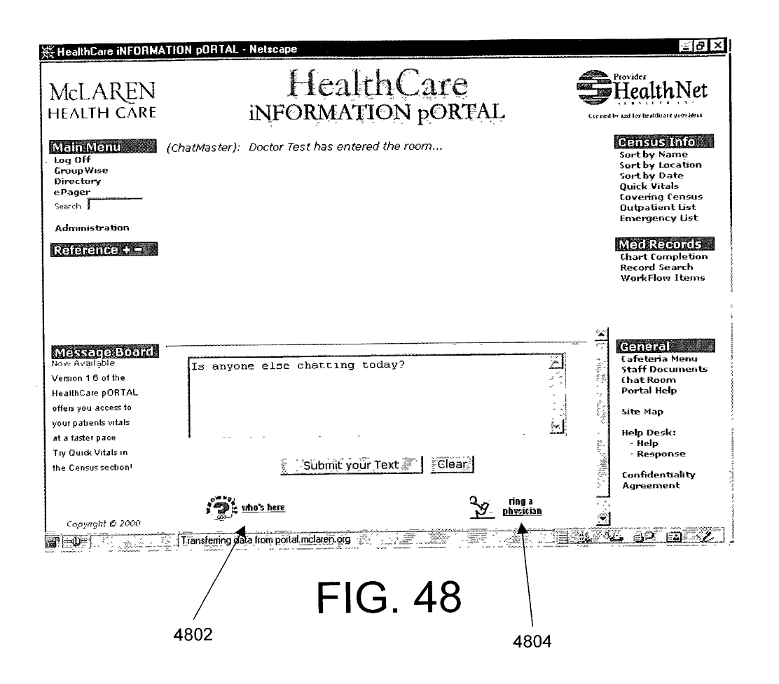

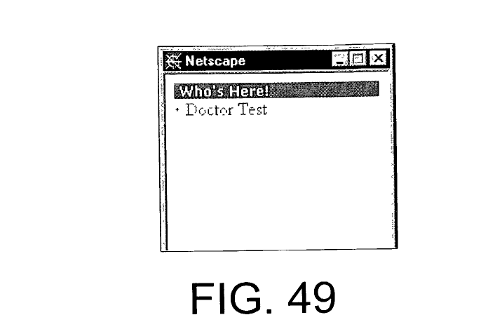

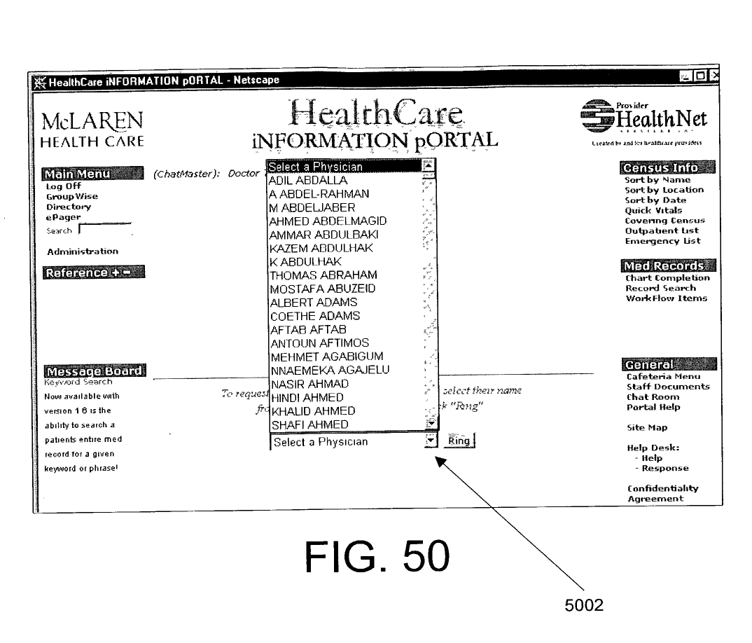

He can look to see “who's here” 4802 and Practitioner can “ring a physician” 4804 shown in FIG. 48 and gets a listing of others in the room by clicking who's here“4802 depicted in FIG. 49. Selecting the ring a physician 4804 option reveals the screenshot depicted in FIG. 50. A physician may be selected from the Select a Physician menu and RING button 5002. If the selected physician is logged on to the Portal then the physician will receive a notice that Practitioner wants to chat with him.

### Accessing GroupWise

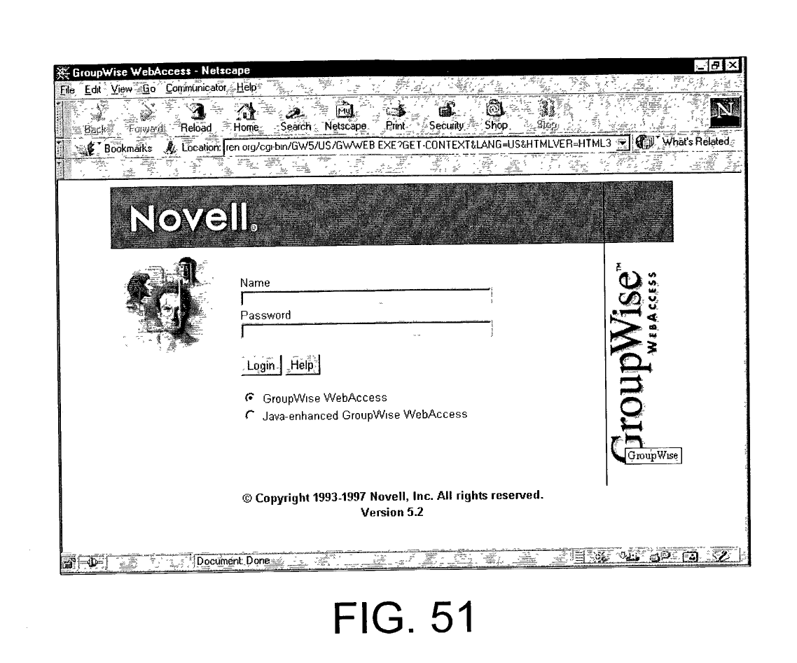

GroupWise may be selected from any screen in the Portal. The screen depicted in FIG. 51 will display prompting Practitioner for his GroupWise logon name and password. Practitioner simply signs on as usual to read or send e-mail messages. When Practitioner is finished with his E-mail, Practitioner clicks on the X in the upper right-hand corner to close his GroupWise account and return to the Portal.

### Accessing the Directory

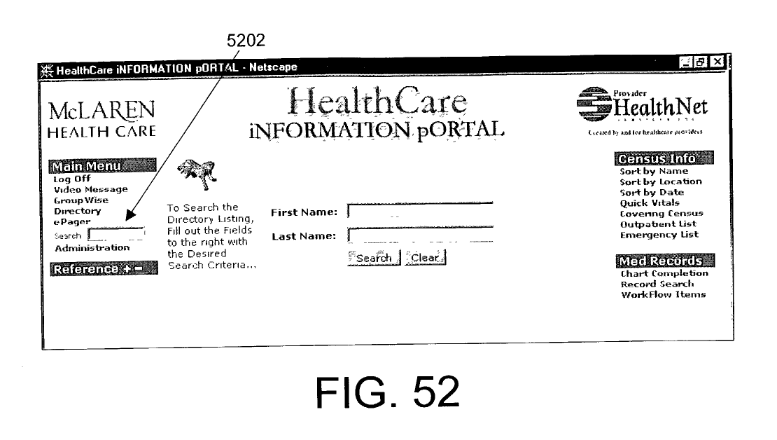

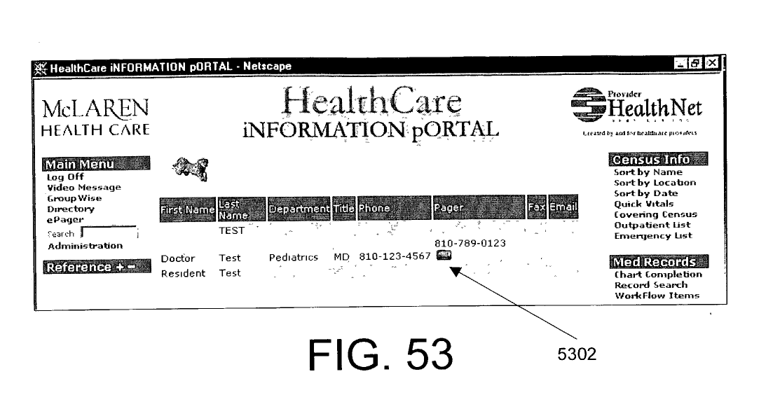

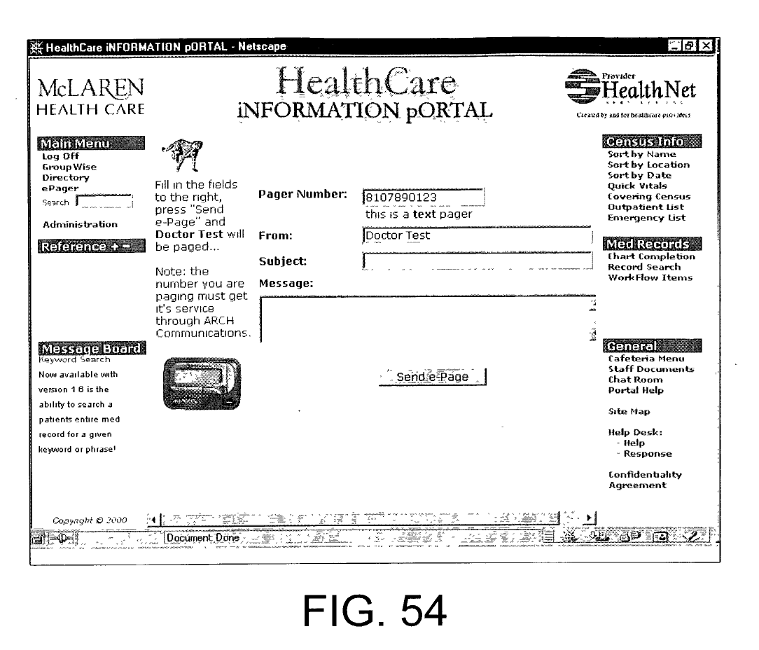

Ordinarily a Practitioner must be logged on to the Portal to access the directory depicted in FIG. 52 because only authorized users are given access to these private numbers. Practitioner clicks Directory from any screen in the Health Care Portal to look up by typing the First Name and/or Last Name of the first person being searched for in the search box 5202 and clicking the Search button when ready. A typical search result is shown in FIG. 53. Notice the Pager icon 5302 next to the Pager number. By clicking on the Pager icon 5302, an ePage may be sent its owner. The pager number is automatically inserted in the Pager Number field. Clicking the pager icon 5302 reveals a screen shot similar to that depicted on FIG. 54. The screen identifies the type of pager, for example a text pager, and gives him a space to write a message. For numerical pagers only a numerical field box is displayed. Practitioner fills in the rest of his information and writes his message. Then Practitioner clicks on Send e-Page. Although the message is sent, Practitioner knows that it goes out to the Internet and through the paging company. Therefore Practitioner has no guarantee of how long it will take for his message to be sent. It usually takes about 2 minutes, however, if the company is having any problems there is no way for Practitioner to know about it. Practitioner decides this is a good way to reach someone but he'll try another method if Practitioner doesn't get a response in a reasonable time.

### Using the ePager

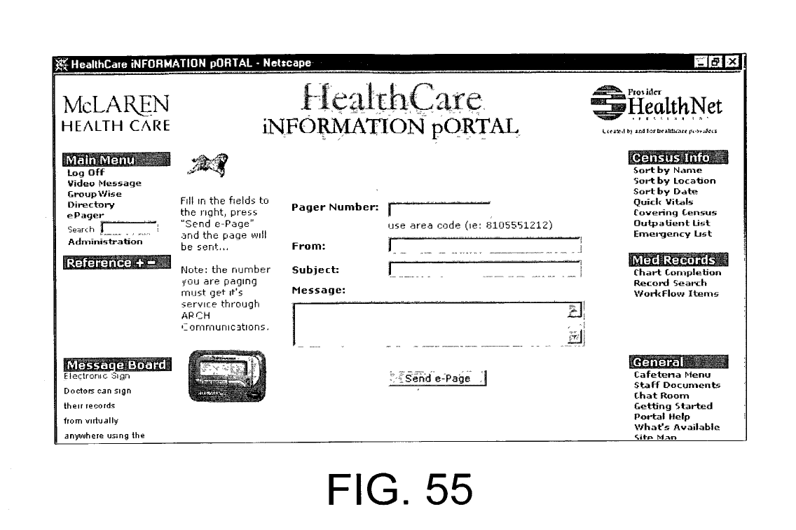

The ePager can be used at anytime, from any screen in the Portal. It can even be used from the “home page screen” before you even log on to the Portal. However, you must know the pager number since you cannot access the Directory unless you log on. Practitioner clicks ePager from the current screen in the Portal depicted on FIG. 55. The person's pager number is then typed in the Pager Number box, his name in the From box, the subject of the page in the Subject box, and his message in the Message box. The Send e-Page is clicked when ready. NOTE: There are several different kinds of pagers. If the recipient has an alphanumeric (or a text) pager, a message box will appear for a text message to be filled in. If the recipient has a numeric pager, then only a text box will appear for a telephone number to be filled in. If they any other paging system, the recipient should be able to get the page but it will be dependant upon the type of service that they subscribe to.

The description of the present invention has been presented for purposes of illustration and description but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for accessing information stored in a plurality of disparate system's databases comprising:
a network;
a plurality of disparate systems connected to said network, each of said plurality of disparate systems comprising:
a memory;
a program application stored on said memory;
an interface for receiving information;
a processor for processing said information by executing said program application; and
a database for storing said processed information, said database having a schema based on one of said program application and a commercial of the shelf database application; and
an enterprise server connected to said network, said server comprising:
a server memory;
a portal application stored on said server memory, said portal application having a data interface for accessing processed information residing in each database of the plurality of disparate systems, said portal application further having a plurality of enterprise task functions for accomplishing enterprise related tasks; and
a server database for storing personal identification data, group membership data and processed information ownership data.

2. The system recited in claim 1 above, wherein said processed information stored in at least one database of the plurality of disparate systems is a plurality of rasterized image documents, said plurality of enterprise task functions for accomplishing enterprise related tasks comprise:
a signature engine for editing at least one of the plurality of rasterized image documents by annotating the rasterized image document with a representative signature.

3. The system recited in claim 1 above, wherein said plurality of disparate systems comprise Admissions, Discharge and Transfers (ADT) system, Radiology system, Medical records/transcriptions system, Pharmacy system and Laboratory system.

4. The system recited in claim 1 above, wherein said plurality of enterprise task functions for accomplishing enterprise related tasks comprise:
a security module for enabling said data interface to access requested processed information residing a database of the plurality of disparate systems based on the ownership data for of requested processed information.

5. The system recited in claim 4 above, wherein said security module enables said data interface to access requested processed information residing a database of the plurality of disparate systems based on personal identification data and information ownership data.

6. The system recited in claim 4 above, wherein said security module enables said data interface to access requested processed information residing a database of the plurality of disparate systems based on personal identification data, group membership data and information ownership data.

7. A data processing system implemented for accessing information stored in a plurality of disparate system's databases comprising:
receiving a request from a requester, said request including data item identification, requester identification and formatting information;
identifying a database holding said data item;
executing a connection string for accessing said data item in said database based on said identify of said database;
retrieving a copy of said data item;
formatting the copy of said data item based on the formatting information; and
passing the formatted data item to said requester.

8. The method recited in claim 7, wherein said request includes a second data item identification, the method further comprises:
identifying a second database holding said second data item;
executing a second connection string for accessing said second data item in said second database based on said identify of said second database;
retrieving a copy of said second data item;
formatting the copy of said data item and said second data item based on the formatting information; and
passing the formatted data item and formatted second to said requester.

9. The method recited in claim 7, wherein said data item is a rasterized image document and the request includes representative signature information, the method further comprises:
acquiring said representative signature information;
annotating the rasterized image document with a representative signature; and
storing said annotating the rasterized image document.

10. The method recited in claim 9, wherein said annotated the rasterized image document is stored in said database identified holding said data item.
